(19) United States
(12) Patent Application Publication
(10) Pub. No.: US 2021/0315169 A1
(43) Pub. Date: Oct. 14, 2021

(54) CONTROL OF LATENT AND SENSIBLE LOADS IN CONTROLLED-ENVIRONMENT AGRICULTURE AND RELATED LIGHTING SYSTEMS

(71) Applicant: MJNN LLC, South San Francisco, CA (US)

(72) Inventors: Yara Thomas, Laramie, WY (US); Joshua John Mark Pero, San Francisco, CA (US); Meaghan Fitzgerald, South San Francisco, CA (US); Nathaniel R. Storey, Laramie, WY (US); Kevin Duane Grauberger, Laramie, WY (US); Alan Colbrie Schoen, Los Gatos, CA (US); Michael Peter Flynn, Palo Alto, CA (US); Anthony Nicholas McDougle, San Francisco, CA (US); Liane Jessica Fang, Redwood City, CA (US); Frances Willcox Esparza, San Francisco, CA (US); Christopher Kwok Wai Mui, San Francisco, CA (US); Grant Thomas Lindblom, South San Francisco, CA (US); Paul Guerra, Redwood City, CA (US); Timothy Michael Murcko, San Mateo, CA (US)

(73) Assignee: MJNN LLC, South San Francisco, CA (US)

(21) Appl. No.: 17/215,318

(22) Filed: Mar. 29, 2021

Related U.S. Application Data
(63) Continuation-in-part of application No. PCT/US19/55064, filed on Oct. 7, 2019.
(60) Provisional application No. 63/007,016, filed on Apr. 8, 2020.
(60) Provisional application No. 63/006,712, filed on Apr. 7, 2020.
(60) Provisional application No. 62/742,751, filed on Oct. 8, 2018.

(51) Int. Cl. A01G 9/24; F24F 11/63; G05B 19/042

(52) U.S. Cl. CPC A01G 9/246; A01G 9/249; H05B 47/10; G05B 19/042; F24F 11/63

(57) ABSTRACT

Systems, methods and computer-readable media are provided for controlling environmental conditions to control latent and sensible loads in a plant grow chamber. The density of plant-0 receptacles in the grow chamber is such that, when plants are held in the plurality of plant receptacles, evapotranspiration contributes to the latent load so that the latent load exceeds a sensible load, resulting in evapotranspirative cooling. This shift in the energy balance allows for greater energy savings, as compared with conventional indoor farms that focus on removing heat from the growth environment. Environmental conditions may be controlled to achieved desired conditions, such as the optimum ratio of harvest weight yield to energy consumption under given constraints. Light modules for enabling plant growth suitable for controlled environment agriculture are also described.

### CROSS-REFERENCE TO RELATED APPLICATIONS

This application claims priority to International Application No. PCT/US19/55064, filed Oct. 7, 2019, which claims the benefit of priority to U.S. Application No. 62/742,751, filed Oct. 8, 2018, both of which are incorporated by reference in their entirety herein.

This application is related to U.S. Patent Application Pub. No. 2018/0014485, filed Sep. 28, 2016, U.S. Patent Application Pub. No. 2018/0014486, filed Sep. 28, 2016, and U.S. Patent Application Pub. No. US 2017/0146226, filed Nov. 15, 2016, all assigned to the assignee of the present disclosure and incorporated by reference in their entirety herein.

### FIELD OF THE DISCLOSURE

The disclosure relates generally to the field of controlled-environment agriculture, and in particular to controlling latent and sensible loads to optimize the ratio of yielded product for each unit of energy consumed (e.g., as represented by yield (e.g., harvest weight) per kw-hour of energy) in a controlled growing environment. The disclosure also relates generally to light modules and light module arrays for use in controlled environment agriculture and, more particularly, to promote growth of plants using elongated grow structures, such as grow towers.

### BACKGROUND

During the twentieth century, agriculture slowly began to evolve from a conservative industry to a fast-moving high-tech industry in order to keep up with world food shortages, climate change and societal changes. Farming began to move away from manually-implemented agriculture techniques toward computer-implemented technologies. In the past, and in many cases still today, farmers only had one growing season to produce the crops that would determine their revenue and food production for the entire year. However, this is changing. With indoor growing as an option and with better access to data processing technologies, among other advanced techniques, the science of agriculture has become more agile. It is adapting and learning as new data is collected and insights are generated.

Advancements in technology are making it feasible to control the effects of nature with the advent of “controlled indoor agriculture” or “controlled-environment agriculture.” Improved efficiencies in space utilization, lighting, and a better understanding of hydroponics, aeroponics, crop cycles, and advancements in environmental control systems have allowed humans to better recreate environments conducive for agriculture crop growth with the goals of greater yields per square foot, better nutrition and lower cost.

Even with these advances, energy consumption and its accompanying cost remain some of the biggest challenges facing indoor farms. Sunlight is free, but indoor lighting, cooling, dehumidification and other climate control methods for large grow rooms can be expensive. Others have tried to reduce energy consumption by employing more energy-efficient lighting and smart energy management approaches, among other means.

Controlled environment agriculture typically requires the use of lighting systems to enable photosynthesis in the cultivated plants. Lighting systems make up a non-neglible portion of the start-up costs and also contribute significantly to the on-going, operational costs of the controlled environment agriculture system—“farm.” As such, the design of the lighting systems to manage component costs during system build and managing overall photon production efficiency, relating to electrical costs and thermal load considerations, during operation is an important factor for controlled environment agriculture.

### SUMMARY OF THE DISCLOSURE

Embodiments of the disclosure optimize yield and energy consumption to maximize efficiency. This is done, in part, by taking advantage of the net evapotranspirative cooling effect of dense plant growth environments to reduce the need for cooling, and by enabling the recycling of waste heat from sources such as grow lights. This shift in the energy balance allows for greater efficiency of energy per kg of yield compared to conventional indoor farms. Additionally, predictive modeling of both yield and energy consumption allows for optimization of both design and system operation in terms of cost and yield, under particular conditions.

Plants convert water and carbon dioxide into energy through photosynthesis. Photosynthesis and many other plant processes also require micronutrients which are transported through the plant tissue by water. Because the plant can only store a small portion of the water required to transport sufficient nutrients, plants must release water to their surroundings. One way in which a plant releases this water is through transpiration. During transpiration, water evaporates from small openings in the leaves called stomata, and then diffuses to the surrounding air. Diffusion is driven by a difference in vapor pressure between the leaf surface and the surrounding air. This pressure difference is referred to as the vapor pressure deficit (VPD), measured in kPa, and is one of the most critical parameters used to estimate transpiration rate. Other factors such as light intensity, CO₂ concentration, nutrient concentration and others can also affect transpiration rate.

If the vapor pressure inside a plant is high (due to, e.g., hydration), water vapor will exit the stomata if the outside air has a lower vapor pressure. As leaf temperature increases at a given air temperature and relative humidity, transpiration rate via the stomata increases. Water is effectively evaporating within or at the surface of the plants' leaves, transferring energy while the phase changes from liquid to vapor. This phenomenon is known as “transpirative cooling.” Evaporation from wet surfaces within the indoor agricultural environment also contributes to cooling. The term “evapotranspirative” cooling refers to the cooling effect due to the phase change of liquid water to water vapor in the form of evaporation off of wet surfaces and transpiration from plants. For convenience “evapotranspiration” will be referred to herein interchangeably as “EVT.”

Evapotranspiration rate is one of the most important parameters to understand for optimization of the system because it both affects mechanical efficiency and is closely related to growth rate and thus yield. Embodiments of the disclosure employ an empirically based model of growth rate and transpiration rate as a function of various environmental parameters paired with a physics based model of mechanical efficiency as a function of environmental parameters and transpiration rate to optimize yield vs. energy consumption.

Conventional approaches focus on cooling the growing environment to offset the sensible heat created by heat sources such as lighting. One approach adopted by Desert Aire accounts for the sensible cooling effect created by evapotranspiration. See “Grow Room Load Determination,” Application Note 25, Desert Aire, March 2016 (“Desert Aire Note”). The Desert Aire approach takes EVT cooling as a given variable that changes as the plants grow, and adjusts HVAC equipment accordingly to account for EVT cooling. The Desert Aire Note discusses modulating sensible heat ratios in response to the grow room environment. The Desert Aire Note provides examples concerning the type of energy (e.g., sensible or latent) that must be removed from the room, demonstrating its focus on cooling the environment.

Like Desert Aire, other conventional HVAC systems in indoor farms treat transpiration as an input, requiring conditioning of other factors to maintain a healthy grow room environment. This leads to equipment that is sized for maximum and worst-case load conditions, which requires flexibility to handle varying loads (such as modulating hot gas reheat in the Desert Aire unit). These requirements make traditional controlled-environment HVAC in indoor farms very capital intensive.

There are two primary loads to the grow space: sensible (energy in the form of heat), e.g., from lights, and latent (energy in the form of water) from evaporation off of wet surfaces and transpiration of the plants.

The heating load is the amount of heat energy that must be added to the grow room space to maintain a target air temperature. This is often considered the heat loss calculation as it calculates the level of heat that must be added to offset the loss through, e.g., the building's ceilings and walls. This heat loss is especially significant in the winter when the outside temperature is much lower than the inside temperature.

The cooling load is the amount of heat energy that needs to be removed to attain the target indoor temperature. This is the heat gain calculation with heat from lighting systems being the most significant portion of this load, plus some contributions from solar gain and the building envelope.

Embodiments of the disclosure provide a control system for controlling one or more environmental conditions to control latent and sensible loads in a controlled agricultural environment (e.g., a grow space such as a fully or partially enclosed grow chamber). The control system may control a sensible load in the grow chamber to provide heat to at least partially offset the latent load. According to embodiments of the disclosure, the density of plant receptacles in the grow chamber is such that, when plants are held in the plant receptacles, evapotranspiration contributes to the latent load so that the latent load exceeds a sensible load, resulting in a net evapotranspirative cooling effect. This shift in the energy balance allows for greater energy savings, as compared with conventional indoor farms that focus on removing heat from the growth environment.

Embodiments of the disclosure control one or more environmental conditions to control a latent load in the grow space, wherein density of a plurality of plant receptacles in the grow space is such that, when plants are held in the plurality of plant receptacles, evapotranspiration contributes to the latent load so that the latent load exceeds a sensible load. Such embodiments control one or more environmental conditions to control the sensible load to provide heat to at least partially offset the latent load, wherein substantially all of the energy input to lighting in the grow space has the effect of warming the air in the grow space.

According to embodiments of the disclosure, more than 80% of the energy input to lighting in the grow space has the effect of warming the air in the grow space. According to embodiments of the disclosure, more than 85% of the energy input to lighting in the grow space has the effect of warming the air in the grow space. According to embodiments of the disclosure, more than 90% of the energy input to lighting in the grow space has the effect of warming the air in the grow space. According to embodiments of the disclosure, more than 95% of the energy input to lighting in the grow space has the effect of warming the air in the grow space.

Embodiments of the disclosure include a dehumidifier for dehumidifying input air from the grow space, and a heat exchanger for transferring heat extracted by the heat exchanger from the input air to dehumidified air at the output of the dehumidifier. Embodiments of the disclosure include a dehumidifier for dehumidifying input air from the grow space, and a heat exchanger for transferring heat extracted by the heat exchanger from the input air to air in the grow space.

According to embodiments of the disclosure, the sensible load, the latent load or both are controlled to achieve at least one desired condition. Controlling the one or more environmental conditions may comprise setting the one or more environmental conditions to one or more environmental setpoints that are determined using a physics based model. The one or more environmental setpoints may additionally be determined using an empirically based model.

The desired condition may be a desired ambient temperature or other setpoint, a desired energy consumption, a desired productivity of plant matter, or a desired ratio of plant product yield to energy use. The control system may employ machine learning to achieve the desired condition. Embodiments of the disclosure may increase or decrease transpiration to, respectively, decrease or increase a sensible cooling load.

The control system may control evapotranspiration to regulate the latent load by controlling at least one of irrigation, CO₂ concentration, or the supply of chemicals (e.g., hormones) that regulate transpiration. The control system may control evapotranspiration by controlling at least one of temperature, relative humidity, vapor pressure deficit, light intensity, light wavelength (including electromagnetic radiation wavelength in the visible range and in the non-visible range, such as ultraviolet and infrared), light duration, or air velocity. The control system may control evapotranspiration by varying lighting based on daytime or nighttime condition. Any factor subject to such control, such as those enumerated above (e.g., irrigation, temperature, lighting) or any other that is characteristic of the grow room environment may be referred to herein as an “environmental condition.”

The control system may control the latent load within a control volume to achieve a desired condition within the control volume. The control volume may include lighting and the plant receptacles. The control system may receive sensor signals representing characteristics of at least one plant or plant environment in the control volume or signals that can be extrapolated to estimate the plant characteristics or environment. Data from the sensors may be used to construct an empirically based model with outputs of transpiration rate and yield.

The control system may include a dehumidification subsystem for dehumidifying the grow chamber and sensible conditioning equipment for sensibly heating and cooling the grow chamber. The control system may employ waste heat to warm the air or evaporate moisture in the grow chamber. Lighting in the agricultural environment may provide the waste heat. The control system may control cooling of the lighting to control the waste heat. More particularly, the control system may include fluid-cooled lighting in the grow chamber as well as a dehumidifier and a heat exchanger. The heat exchanger may employ waste heat from the lighting in the grow chamber or from components within an air and fluid conditioning system to heat air output from the dehumidifier and provide the heated air to the agricultural environment.

In some embodiments, the disclosed lighting systems provide light which is used for photosynthesis by plants on grow towers. In one implementation, these systems may be configured for use in automated crop production systems for controlled environment agriculture. The present invention, however, is not limited to any particular crop production environment, which may be an automated controlled grow environment, an outdoor environment or any other suitable crop production environment. In some embodiments, the disclosed lighting systems may be used as work lights (e.g., for home projects, construction projects, or the like). In some embodiments, the disclosed lighting systems may be used for sterilization (e.g., in sterilization cabinets with the light modules adapted to emit UV wavelengths).

### BRIEF DESCRIPTION OF THE DRAWINGS

FIG. 1 illustrates a control volume including lighting and a number of plants, according to embodiments of the disclosure.

FIGS. 2, 3 and 4 are psychrometric charts used to illustrate heating and cooling in a control volume, according to embodiments of the disclosure

FIG. 5 illustrates a feedback-based environmental conditioning system, according to embodiments of the disclosure.

FIGS. 6A and 6B illustrate embodiments of a conditioning system that takes advantage of the evapotranspirative cooling effect to control sensible and latent loads.

FIG. 7 illustrates an example of a computer system that may be used to execute instructions stored in a non-transitory computer readable medium (e.g., memory) in accordance with embodiments of the disclosure.

FIG. 8 depicts an example of an empirical relationship between transpiration rate and VPD.

FIG. 9 depicts a simplified flow chart of inputs and outputs for the physics based and empirically based component models, according to embodiments of the disclosure.

FIG. 10 is a psychrometric chart illustrating identification of desired conditions, according to embodiments of the disclosure.

FIG. 11 is a simplified diagram of a physics based model employing the Heat Balance Method.

FIG. 12 illustrates an exemplary light module.

FIGS. 13A-D illustrate multiple views of the light module illustrated in FIG. 12.

FIG. 14A shows schematic arrangements of various light module arrays.

FIGS. 14B and 14C show the light output of two light module arrays.

FIG. 14D show an illustration of a close-up view of a two light module arrays.

FIG. 14E show an illustration of the two light module arrays from FIG. 3D.

FIG. 14F shows a top-view illustration of two light modules from the light module arrays shown in FIG. 14E.

FIG. 15 shows a schematic view of of a light module array.

FIG. 16 shows an illustration of a light module array with components mounted near the bottom.

FIGS. 17A-D show illustrations of various air handling systems to provide air flow near light modules.

FIGS. 18-20 show illustrations of various embodiments of light modules.

### DETAILED DESCRIPTION OF EMBODIMENTS OF THE DISCLOSURE

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the disclosed embodiments, but is to be accorded the widest scope consistent with the claims and the principles and features disclosed herein.

System Mechanics

This section first discusses loads within a grow space and then discusses methodologies used to handle those loads to maintain the environment at desired conditions, according to embodiments of the disclosure. Embodiments of the disclosure treat the problem differently than conventional systems by leveraging the transient nature of the loads implicit to the abundance of biological material within the conditioned space. According to embodiments of the disclosure, because the implication of various operational strategies on growth rate and energy consumption is non-linear, a unique empirical model is utilized along with a physics based mechanical efficiency model to optimize the system.

Loads

In standard HVAC design, the peak load defines the maximum amount of heating, cooling and dehumidification that is required to maintain the conditions within a space to achieve desired environmental setpoints (e.g., temperature, relative humidity) under a worst case scenario. The term “load” is used herein rather than “peak load” because it is used to describe the amount of heating, cooling, and dehumidification that is required at a given time and the load may vary significantly based on changes in system operation. When computing the load there are two primary components that are used to describe the amount of heating, cooling and dehumidification. These components are sensible and latent loads.

The sensible load refers to the amount of heat energy that needs to be added or removed from a space in order to maintain a desired setpoint temperature. Examples of factors that contribute to the sensible load are heat from lights, heat from mechanical equipment, and heat from infiltration of air from the surroundings.

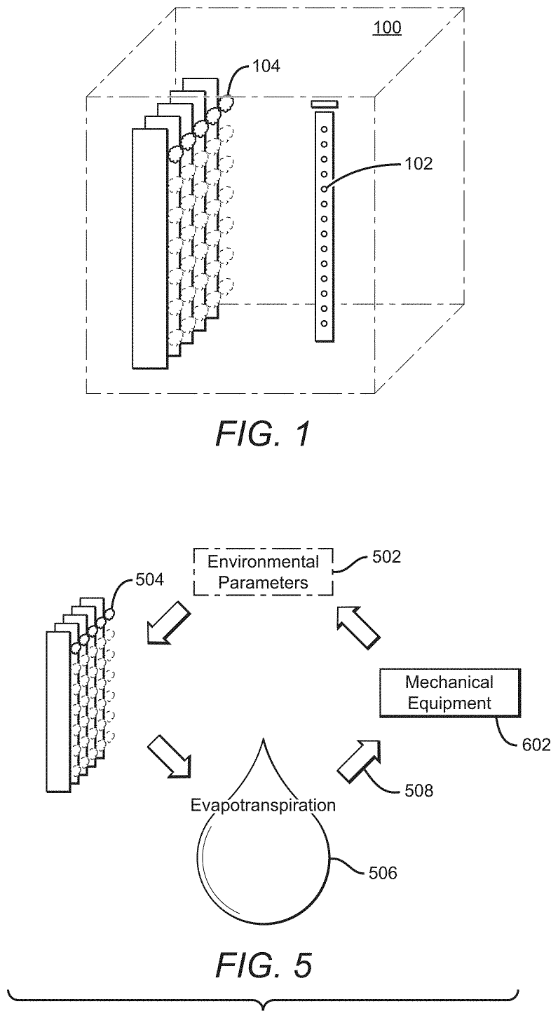

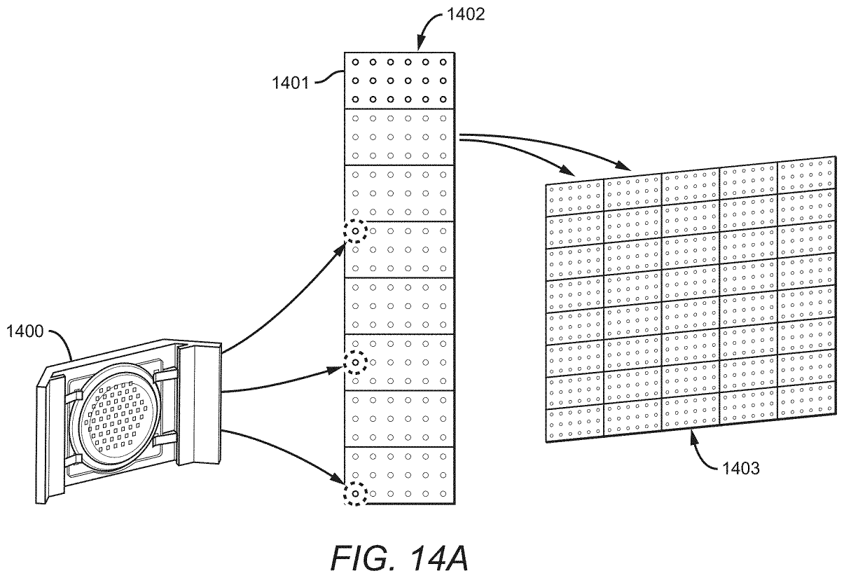

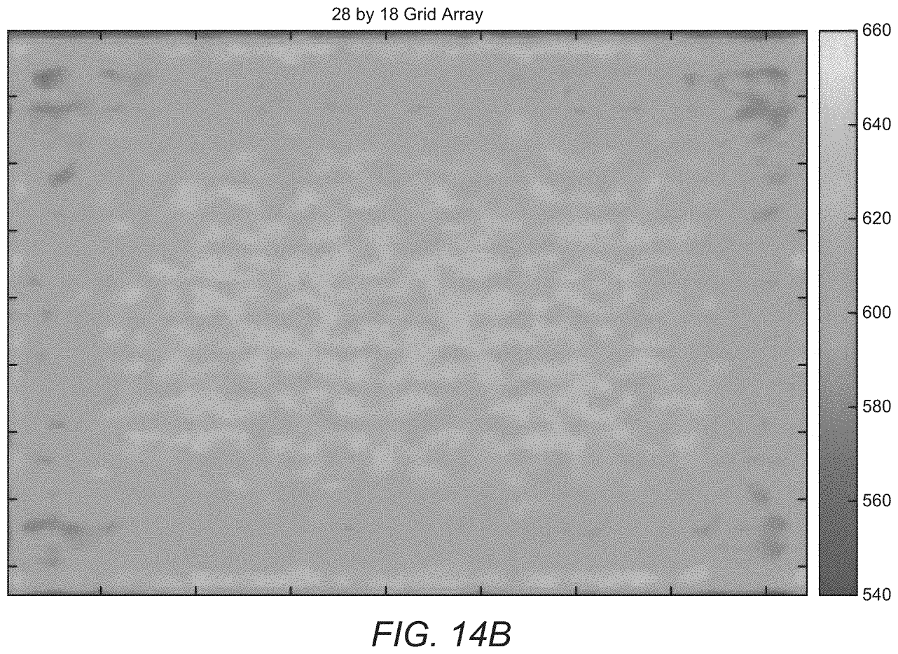

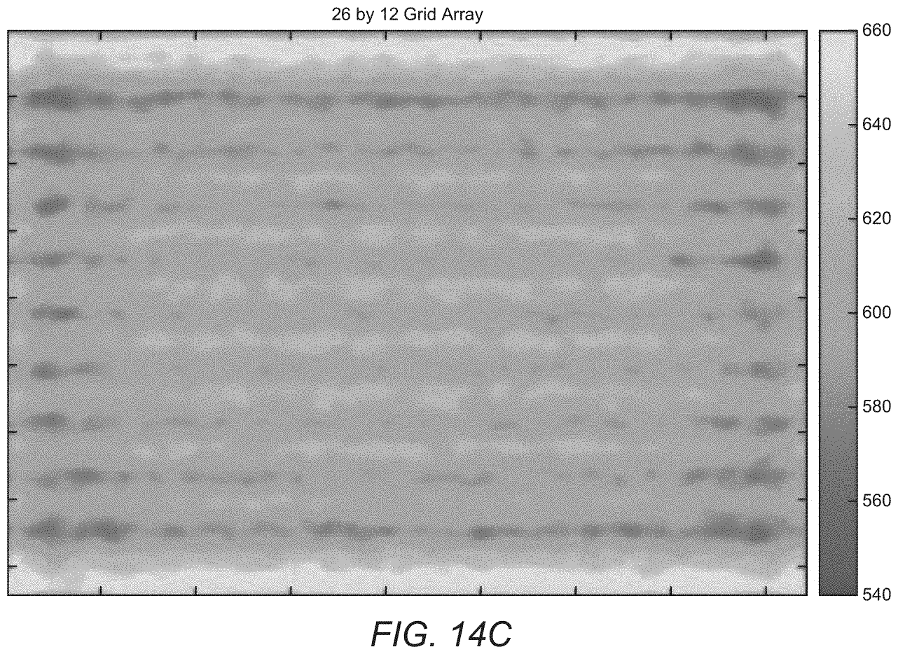

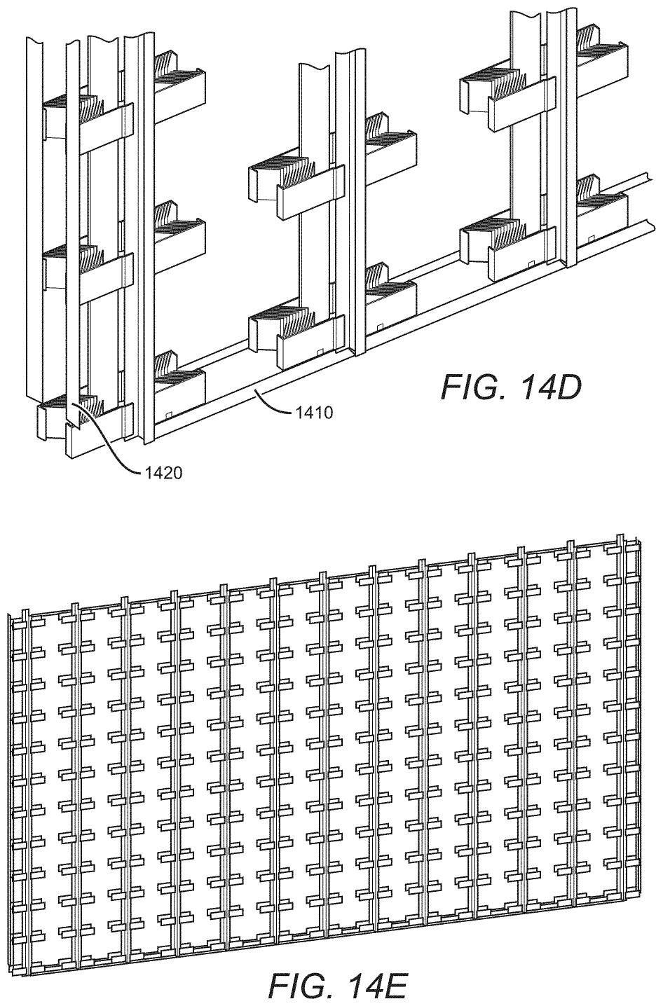

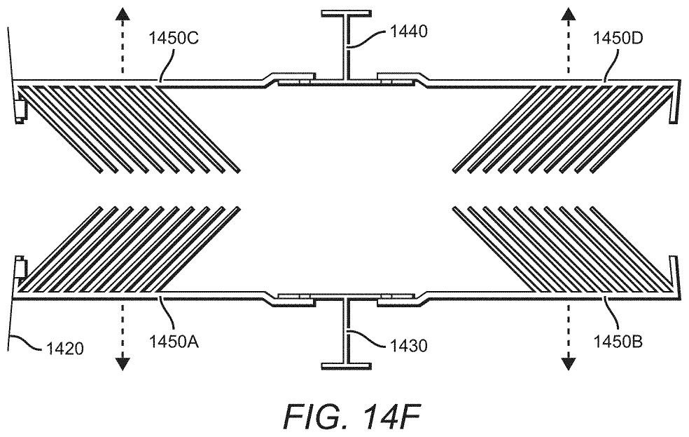

The latent load refers to the amount of energy in the form of water that must be removed or added to a space in order to maintain a desired relative or absolute humidity setpoint. An example of a latent load is evaporation from wet surfaces and transpiration of the plants. Here, a control volume 100, as shown in FIG. 1, is used to discuss the loads and required environmental control in a way that is representative of a space, but independent of room size and layout. For the sake of discussion, the illustrated control volume 100 includes lighting 102 (e.g., light module array 1403 from FIG. 14A, light module array from FIG. 14E) and a number of plants 104 associated with that fixture. Similarly, the variable of time may be eliminated by normalizing all rates to a one-hour interval.

Associated with each unit surface area of leaf is a transpiration rate. Transpiration is the process by which plants release water to the air through stomates in the leaf surface. As the liquid water within the plant is converted to water vapor, it absorbs a large amount of energy. This has a cooling effect on the air within the space. Transpiration rate as well as surface area will vary based on age of the plant, variety, treatment, and environmental conditions.

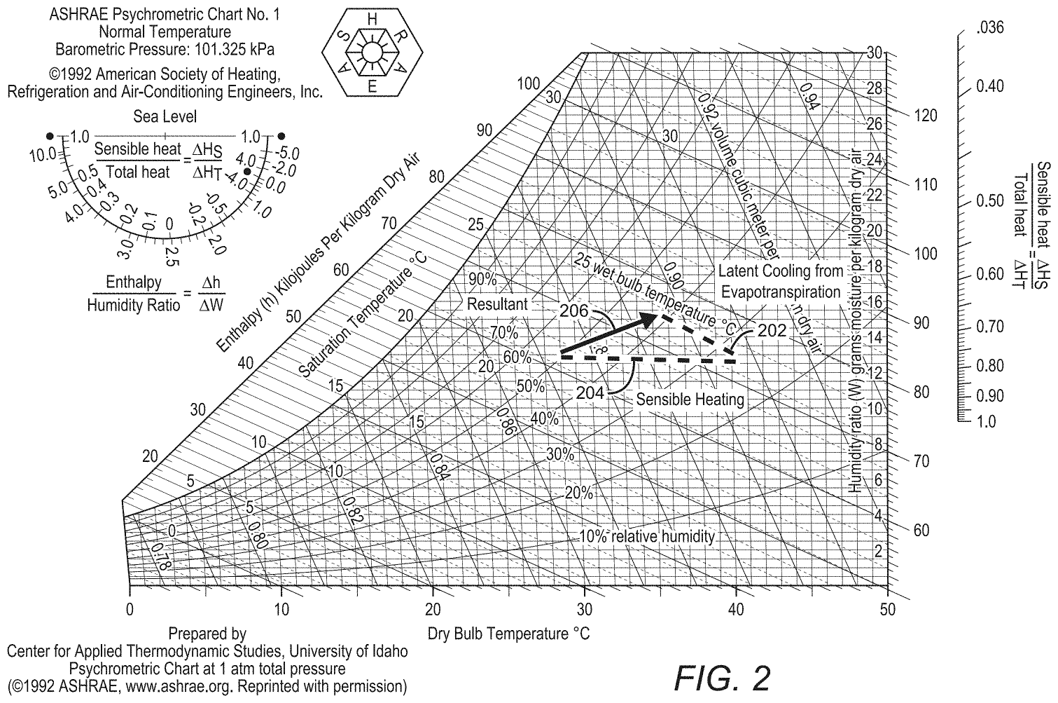

FIGS. 2, 3 and 4 are psychrometric charts used to illustrate heating, cooling and dehumidification in the control volume, according to embodiments of the disclosure. Referring to FIG. 2, the rate of total transpiration within the control volume plus the rate of evaporation (latent load) can be represented as a latent vector, as shown by the dashed line 202. The lighting has a sensible load 204 associated with it, which is a result of energy input to the lights that is not absorbed through photosynthetic processes. These vectors have net total effect represented by a resultant vector (solid line) 206. This line represents the total load within the control volume. The length of the sensible and latent components, and thus the resultant component, can also be proportionally affected by increasing or decreasing the rate of air exchange through mechanical ventilation. However, this only affects the magnitude and not the resultant direction.

Depending on the magnitude of each component vector, the slope of the resultant (solid) line will change. FIG. 2 shows the resultant vector that might occur in a conventional system. In this example the ratio of latent:sensible energy is much smaller than one. This results in heating of the space and a drop in relative humidity as a result of the increased temperature (even though absolute humidity increases).

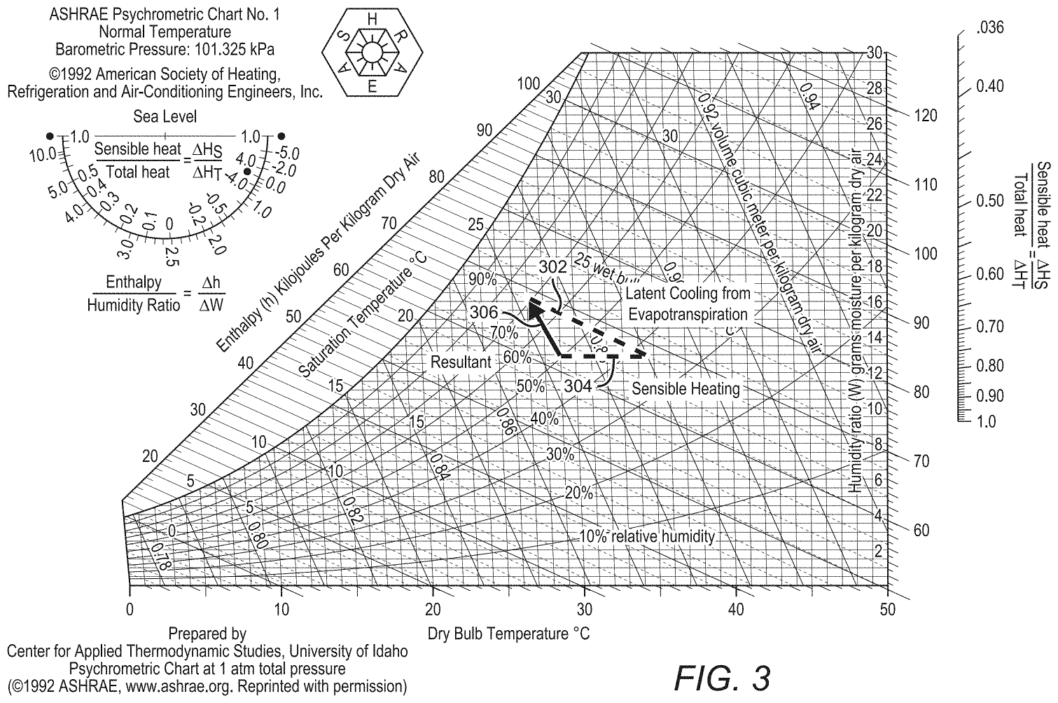

FIG. 3 depicts a psychrometric chart with a latent:sensible ratio greater than 1, according to embodiments of the disclosure. The sum of a latent cooling vector component 302 larger than the sensible heating component vector 304 has a net resultant EVT cooling effect on the room, as shown by resultant vector 306. As demonstrated in the figure, the relative humidity increases rapidly while the temperature drops.

Systems according to embodiments of the disclosure maintain a plant density such that the result of sensible and latent loads on the room has a cooling or heating effect that may be premeditated by system design and predictive modeling. The density may be expressed as the leaf surface area per unit volume (which may be expressed in cm²/m³ or m²/m³, for example). The density of the plants is arranged such that within a control volume, the latent-sensible ratio

(T*A*L+E*L)/S is optimized for energy efficient operation,

where:

T=Transpiration rate for a unit area of leaf (kg/(m²*hr))

T is a function of crop type, time since seeding, environmental conditions, nutrient treatment, light intensity, and other known factors, and may be predicted by a predictive model, such as the empirically based model described elsewhere herein

A=Leaf area within the control volume (m²)

L=Latent heat of vaporization of water (kw/kg)

E=Rate of evaporation within the control volume (kg/hr)

S=Rate of sensible heat transfer to the space (kw/hr)

The resulting parameter is dimensionless for the one-hour period.

According to embodiments of the disclosure, a controller 620 (described below) may optimize the latent-sensible ratio through a variety of optimization schemes, including machine learning, using, as inputs/features, crop type, time since seeding, environmental conditions (e.g., temperature, relative humidity), nutrient treatment, light intensity, or other known factors, as well as those represented by the variables A, L, E, and S above, with the objective of improving plant yield per unit energy consumption, flavor or other parameters, alone or in combination.

As an example for a one cubic meter control volume, the controller 620 (described below) may achieve evapotranspirative cooling by optimizing parameters to take on the following values:

T=0.0088 kg/(m²*hr) and A=3.42(m²) for:
i. crop type: Romaine lettuce
ii. time since seeding: 24 days
iii. Temperature: 18.5 C during lights off, 22.5 C during lights on
iv. Relative humidity: 65 percent
v. At a given nutrient treatment, light intensity, and other factors

L=0.67

7 kw/hr

E=0.0044 (kg/hr)

S=0.195 (kw/hr)

Because transpiration rate is variable, a controller (such as controller 620) controlling appropriate equipment to condition the environment of the grow space may manipulate the direction of the resultant arrow on the psychrometric chart, according to embodiments of the disclosure. By taking advantage of evapotranspirative cooling in the grow space, embodiments of the disclosure may employ the sensible heat added to the space in a beneficial, rather than detrimental, manner with respect to operational efficiency of the system.

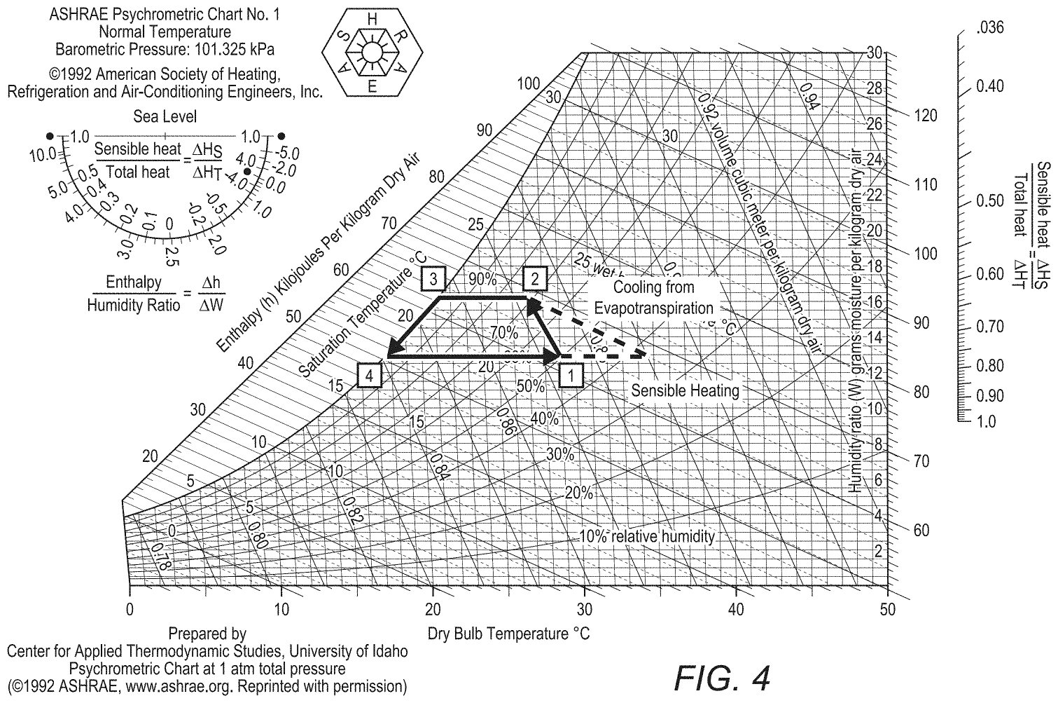

FIG. 4 illustrates on a psychrometric chart the cyclical process that air follows, according to embodiments of the disclosure. Arrow 1-2 represents the air as it circulates through the grow space. The remaining arrows represent the treatment of the air as it flows through a conditioning system (such as conditioning system 602 described below) until it is returned back to the grow space after reheating (4-1). Arrow 1-2 shows the same process as in FIG. 3, where the latent:sensible ratio is greater than 1. According to embodiments of the disclosure, the conditioning system 602 under control of the controller 620 then sensibly cools the air (2-3), which may be accomplished by passing it over mechanical dehumidification coils. As illustrated, the air itself is not dehumidified during this step; just the dry bulb temperature drops. As the air is cooled, it reaches saturation, resulting in condensation (3-4), removing water from the air (dehumidification). To bring the air back to environmental operating conditions (e.g., dry bulb temperature, humidity) for desired plant growth, the conditioning system 602 may sensibly reheat the air to the operating point 1 (4-1), according to embodiments of the disclosure. The conditioning system 602 then returns the air to the grow space.

In most conventional systems, the resultant arrow of sensible and latent loads is tilted towards the right as in FIG. 2 (latent:sensible <1), and point 2 ends up farther from point 3. This means that to reach saturation more sensible energy must be extracted from the air (i.e., be cooled) in the grow space of FIG. 2 than in the grow space of FIG. 3. By taking advantage of the EVT cooling effect within the grow space, embodiments of the disclosure reduce the amount of work that must be done by the energy-intensive HVAC system

In the example of FIG. 4 where the resultant vector (1-2) is tilted towards the left (latent:sensible >1), the temperature change within the room acts to pre-cool the air before it is conditioned. While the need for cooling is reduced, the need for re-heating (4-1) increases. Embodiments of the disclosure efficiently deal with this effect by capturing and using waste heat from other parts of the system. By evaporatively cooling internal to the grow space, the cooling load is decreased while the heating load increases. The increase in heating load is easily met through the use of waste heat.

Conditioning System

According to embodiments of the disclosure, the conditioning system is designed to respond to and handle loads in the grow space. Embodiments of the disclosure recognize and make use of the flexibility of the latent:sensible load ratios. Referring to FIG. 5, rather than treating the system as linear, the concept of embodiments of the disclosure is cyclical. According to embodiments of the disclosure, the controller 620 may adjust operation of the conditioning system 602 (which may include mechanical equipment such as dehumidifiers, condensers, heating coils) to reach desired environmental parameters (502). These environmental parameters 502, in turn, affect growth of the plants (504) and evapotranspiration (506). According to embodiments of the disclosure, the controller 620 may process sensed temperature, humidity and other environmental conditions (508) in the grow space to adjust the conditioning system in a feedback loop to achieve desired conditions.

In some embodiments, a farm control system may control one or more aspects of the farm including: moving plants into and out of the grow space 600, feeding plants in the grow space 600, or harvesting the plants after they are removed from the grow space 600. In some embodiments, some or all of the functions of the controller 620 may be performed by the farm control system. In some embodiments, the controller 620 may receive instructions from the farm control system to perform some or all of the functions described herein as performed by the controller 620.

Conventional HVAC systems treat sensible and latent loads as a fixed input to sizing and energy use calculations. In many ways this is a holdover from traditional building design where the controlled environment is designed for human comfort. In reality, plants are much more resilient and flexible than human comfort standards. The traditional methodology of defining worst case loads and sizing for such loads leads to oversized, expensive equipment designed for a very specific operational condition. By recognizing that the loads can be manipulated, there is a large, unrecognized potential to cut capital as well as operational costs.

The level of control and flexibility built into the system can be optimized for plant health and efficiency. A controlled vapor-pressure-deficit, among other variables, can maintain nutrient uptake and effectively grow the same volume of crop in a small volume of air with lower energy consumption.

According to embodiments of the disclosure, the controller 620 utilizes two model components to determine environmental conditions that optimize the system (e.g., grow space 600, including lighting 608 (e.g., a lighting fixture), CO2 supply 611, irrigation system 609, and conditioning system 602) for yield vs. energy consumption. For the sake of convenience, this disclosure will refer to the controller 620 as performing this function, but those skilled in the art will recognize that in other embodiments one or more other computing devices may perform the same function, and provide their determination to the controller 620 to control the conditioning system 602, among other things. The two model components share many inputs, including, e.g., temperature, relative humidity, light intensity, light spectrum, CO2 concentration, and mechanical ventilation rate.

The first component is an empirically based model for predicting yield and transpiration rate as a function of many parameters. The output transpiration rate is used as an input to the second model component, which is a physics based model used to predict energy consumption of the system.

According to embodiments of the disclosure, the first, empiricially based model component uses data collected via a sensor network to establish numerical relationships between a fixed number of environmental and plant parameters and yield and transpiration rate. Environmental and plant parameters may include temperature, relative humidity, light intensity and spectrum, CO2 concentration, plant variety, plant age, nutrient concentrations, and others. In general, these numerical relationships are determined by systematically varying a single parameter or multiple parameters while observing the effect on the output parameters. According to embodiments of the disclosure, the controller 620 applies to this empirical data predictive techniques, such as a multivariate regression model or machine learning, to relate all the parameters to yield and transpiration rate.

FIG. 8 depicts a simple example of an empirical relationship between transpiration rate and VPD, found experimentally by varying VPD while holding other parameters constant. The controller 620 may use regression techniques, e.g., multiple linear regression, polynomial regression, to determine a best-fit line to numerically represent the relationship, and to predict transpiration rate as a function of VPD along with other parameters that are held constant in this example. The resulting understanding of variable relationships determined empirically is bounded by physiological and physics based limitations. An example of a physical limitation is that transpiration rate must drop to zero as the vapor pressure deficit drops to zero. This is because it is physically impossible to evaporate additional water when the air is already at 100 percent relative humidity.

According to embodiments of the disclosure, the controller 620 uses the physics-based model component to predict the efficiency (amount of work performed/energy consumed) of the mechanical system (e.g., conditioning system 602, lighting 608, CO2 supply 611, irrigation system 609) given various operating conditions such as temperature, relative humidity, VPD, CO2 concentration, mechanical ventilation rate, light intensity and transpiration rate. From efficiency, the total energy consumed is determined for use in determining the desired yield-to-energy (Y/E) ratio.

According to embodiments of the disclosure, the physics based model determines total system efficiency (amount of work performed/energy consumption) using the predicted transpiration rate, conventional psychrometric equations as defined in ASHRAE and as reflected in psychrometric charts such as those in FIGS. 2-4, and mechanical equipment operating curves provided by the manufacturers of the components of the environmental conditioning system 602, lighting 608, CO2 source 611, and irrigation system 609. The amount of work performed reflects the amount of heating, cooling or dehumidification implemented in the system.

According to embodiments of the disclosure, the physics based model employs the Heat Balance Method such as that outlined in J. Spitler, Load Calculation Applications Manual, second edition, I-P edition, ASHRAE (2014) (the “ASHRAE manual”), incorporated by reference in its entirety herein. This manual is an in-depth, application-oriented reference that provides a clear understanding of state of the art heating and cooling load calculation methods plus the tools and resources needed to implement them in practice. Although one skilled in the art would know how to compute system efficiency with the above inputs, embodiments of the disclosure also incorporate predicted transpiration rate into the efficiency computation as at least part of the latent load.

The physics based model employing the Heat Balance Method, as depicted in the simplified diagram of FIG. 11, assumes that, at steady state, the energy flows in and out of the control volume, referred to as a “zone” in the ASHRAE manual, must sum to zero. Another fundamental assumption is that the air in the space can be modeled as well-stirred. This means that temperature and humidity can be approximated as constant throughout the space, although they may vary over time.

In this model, the controller 620 identifies and sums the primary energy and mass (e.g., water) sources and sinks, and uses the sum to estimate the amount of work (e.g., the total of sensible and latent loads) that the conditioning system 602 must do to maintain the setpoint conditions (i.e., the amount of work performed in the numerator of the total system efficiency computed above). In FIG. 11, the supply air conditions 950 or the return air conditions 952 (e.g., temperature, humidity) can be found by respectively subtracting or adding the loads from the return air condition or to the supply air condition, respectively. An example of this would be adding supply temperature in degrees K to the amount of total heat in kJ divided by the mass flow of air per second and divided by the heat capacity of air to find the return air temperature:

T_{return_air}=T_{supply_air}+total_load=T_{supply_air}+total_heat/(mass_flow_rate*heat_capacity)

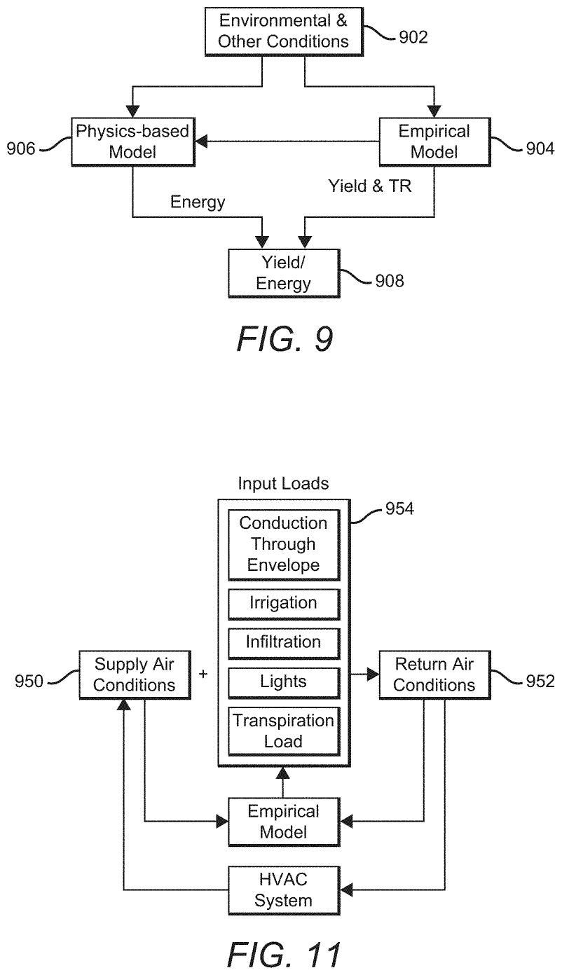

FIG. 11 also depicts the empirical model using supply and return air conditions 950, 952 along with other inputs, such as input loads 954, to calculate the transpiration load, as described with respect to FIG. 9.

Values derived from the the Heat Balance Method provides conditions to use with the mechanical equipment operating curves mentioned above in order to determine system efficiency. Using the system efficiency, energy consumption at any given point (instantaneous energy) during a grow cycle (length of time it takes a plant to mature to harvest weight) may be computed for given environmental conditions and estimated transpiration rate for the age of the subject crop in the grow space, according to embodiments of the disclosure. According to embodiments of the disclosure, the instantaneous energy is integrated over the full length of the grow cycle to determine total energy consumption (the variable E used in computing the ratio of yield to energy consumption). The unique aspect of this model is that transpiration rate is treated as a controllable variable that is determined based on the empirical model. The physics based model component allows for a variable transpiration input which can be used for yield and energy optimization.

According to embodiments of the disclosure, the controller 620 uses the two model components to estimate the impact on energy and yield of various operational strategies. FIG. 9 depicts a simplified flow chart of inputs and outputs for the component models. Block 902 represents the inputs to both model components. According to embodiments of the disclosure, the inputs include a fixed number of parameters that influence mechanical efficiency, transpiration rate, or yield. These parameters may include temperature, relative humidity, CO2 concentration, nutrient concentrations, crop variety, crop age, air velocity at the plant level, mechanical air exchange rate, light intensity, light spectrum, volumetric flow of nutrient water, infiltration rate, and thermal mass of the physical components in the grow system.

Block 904 represents the empirical model with outputs of yield and transpiration rate. Block 906 represents the physics based mechanical system model, which receives as inputs transpiration rate from block 904 and the parameters from block 902. According to embodiments of the disclosure, the controller 620 employs the physics based mechanical system model (906) to predict energy consumption, as described elsewhere herein. The controller 620 uses the predicted energy consumption along with the yield predicted by the empirical model component 904 to determine the desired condition of the ratio of yield/energy consumption (e.g, in kg/kwh) (908).

Determining temperature and relative humidity setpoints is one example of how the two-component model can be used for optimization. In an example, consider a two dimensional parametric analysis of various temperature and relative humidity setpoints. In a prophetic example, the result of this analysis may be the yield divided by the energy (kg/kw-hour) over the course of a 10 day grow cycle where temperature is varied by increments of 1 degree from 18 to 40 degrees C. and relative humidity is varied by 1% from 55% to 85%. In this example, the controller 620 may determine that the kg/kw output is maximized at 22 degrees and 80% relative humidity.

This type of analysis is valuable because it allows operators to quantify the tradeoffs of various scenarios which are not immediately apparent. For example, in the above scenario where temperature is varied, the mechanical equipment may be more efficient at a higher temperature whereas yield is higher at a lower temperature. The controller 620 may also determine that there is a higher transpiration rate at higher temperatures and thus an increased dehumidification load which leads to increased energy consumption. From a purely mechanical standpoint, one would expect energy consumption to be reduced when operating at a higher temperature when cooling. For example, refrigeration equipment requires more energy per unit of work output at colder temperatures because there is less heat per unit of air, but when coupled with the empirical model, the model predicts that the system is optimized at a temperature setpoint where the mechanical equipment is actually running less efficiently.

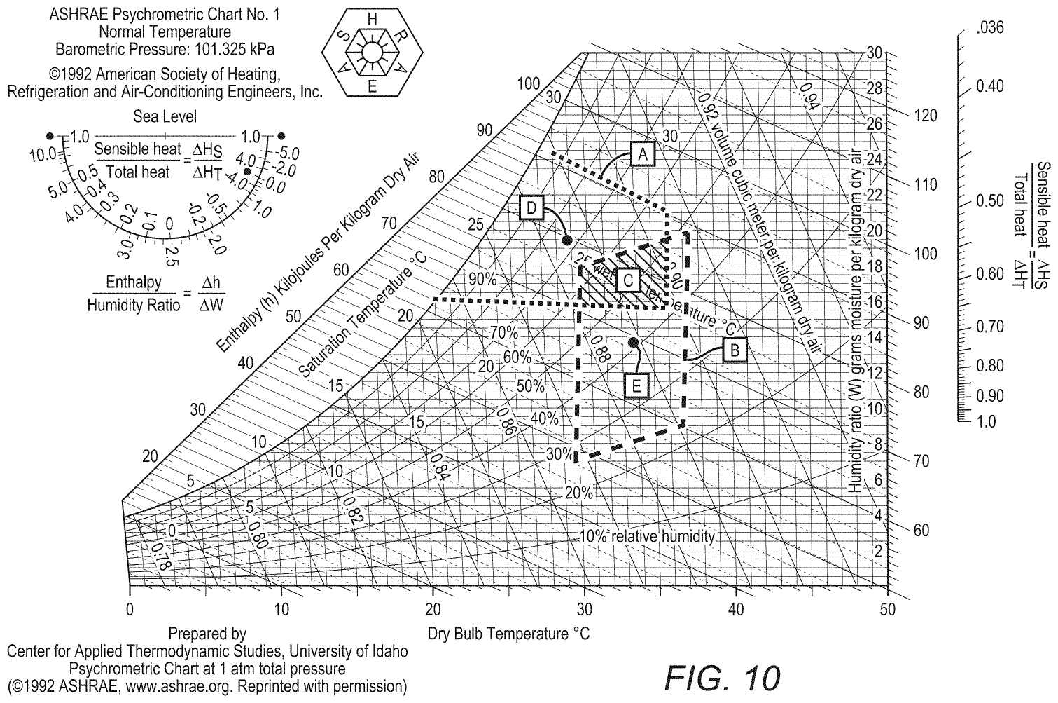

FIG. 10 provides a visualization of this concept. In this example, using the physics based model 906, the controller 620 determines that Region A represents the combinations of temperature and relative humidity for which the energy consumption of the system is less than 110% of the minimum energy use (minimum represented by point D) under conditions in which temperature and relative humidity are varied and all others held constant.

In this example, using the empirical model 904, the controller 620 determines that Region B represents the region in which yield is greater than 90% of the maximum yield (maximum represented by point E) under the same conditions. As noted, points D and E represent minimum energy consumption and maximum yield. However, because those points do not overlap, the ideal, maximum ratio of yield/energy cannot be achieved, in this example. Therefore, the inventors determined to establish regions around the ideal setpoints to generate an overlap region in which the optimum Y/E ratio could be found within real-world constraints.

Note that the system operator may vary the allowable percentages above based upon the cost of energy and the profit from yield (e.g., harvest weight) as dictated by market conditions. An objective is the highest profit from yield per unit cost of energy. As an example, if energy costs were to increase, the allowable percentage from minimum cost would decrease because the cost factor would be more critical.

Using the boundary values of Regions A and B, the controller 620 identifies that the resultant overlapping window C is the region in which the system can operate and achieve a desired, optimum yield to energy ratio within real-world constraints. In this example, Region C represents acceptable temperature and relative humidity environmental conditions that are predicted to achieve energy consumption of less than 110% of the minimum energy use and a yield greater than 90% of the maximum yield in the example above, i.e., each environmental condition falls between lower and upper thresholds of acceptable environmental parameter values that achieve those objectives.

According to embodiments of the disclosure, the controller 620 selects particular environmental conditions from within the range of acceptable setpoints (as represented by the overlap region C in this example) to determine target setpoints to be applied through the environmental conditioning system 602 to the grow space 600. It is desired that both supply and return conditions fall within Region C. Referring to FIG. 4, point 1 represents temperature and relative humidity conditions of the supply air. Point 2 represents the effect of the sensible and latent loads that result in temperature and relative humidity conditions of the return air.

To operate most efficiently in this example, it is desired that both supply and return conditions fall within Region C. Maximizing the magnitude (length) of load line 1-2 minimizes the rate of air exchange and energy demand of the supply fan necessary to maintain supply and return within Region C. Thus, according to embodiments of the disclosure, the controller 620 selects the supply and return temperature and relative humidity setpoints as the endpoints of the longest load line 1-2 (which is at an angle defined by the ratio of the latent load to the sensible load) that fits within Region C. The longest line represents taking the greatest advantage of the evapotranspirative cooling effect (because its endpoint is at the coolest point in the x direction within region C) and specifies operating conditions that are predicted to hit the desired ratio of yield to energy consumption.

Benefits of HVAC systems designed according to embodiments of the disclosure include:
Efficient dehumidification or moisture removal from the control environment. Moisture removal includes replacement of the existing air in the grow space with outside air, whether conditioned or not.
Control of sensible and latent loads allowing systems to run precisely at the most efficient operating conditions.
Flexibility to handle varying latent:sensible ratios, within a given system capacity.
The heat from lights and other mechanical components is beneficial. By controlling and capturing the heat, it can be used to reheat the supply air or control volume to the desired temperature after mechanical dehumidification.
Lights can run at a high temperature to reject heat directly to the space.
Waste heat is collected and exchanged back to the air using heat recovery devices such as a heat recovery chiller.
The latent:sensible ratio can be adjusted based on requirements of the system, such as desired heating and cooling capacity of the air and fluid conditioning system, and differences in night and day heating and cooling requirements.

Control of Sensible Loads

Embodiments of the disclosure adjust the sensible load by altering light intensity or cooling the lights (see, e.g., U.S. Patent Application Pub. No. US 2017/0146226, filed Nov. 15, 2016, assigned to the assignee of the present invention and incorporated by reference herein in its entirety). For example, the conditioning system may adjust the flow rate through water-cooled lighting to affect whether heat generated at the fixture is rejected to the grow space air or whether it is removed via the water.

According to embodiments of the disclosure, the controller 620 may control the appropriate equipment (e.g., in environmental conditioning system 602) to regulate the sensible load in the grow space by controlling variables such as:
Water temperature and flow rate delivered to the water-cooled lights changes the amount of heat rejected to the control volume, vs. carried away in the water, all while maintaining lights at acceptable conditions.
Pulse-width modulation allows control of lighting power consumed at the fixture algorithmically with other input variables
LED choice, power consumption, density, and thermal properties of the lighting construction.
Operation of other equipment that may act as a heat source.

Control of Latent Loads

According to embodiments of the disclosure, the controller 620 may control the appropriate equipment (e.g., in environmental conditioning system 602) to regulate the evapotranspiration rate in the grow space by controlling variables such as:
Vapor pressure deficit, and temperature and humidity setpoints
Evaporation from surfaces and grow equipment
Airflow velocity and directionality
Quantity, varietal, age, and spacing of plants in a space
CO₂ concentration
Light intensity and duration
Watering frequency, intensity, and duration
Nutrient mix
Chemicals including hormones that can increase or decrease plant transpiration. The chemicals may be added to the nutrient mix.

According to embodiments of the disclosure, the environmental control system equipment is specified to remove an equivalent or larger amount of water than occurs during worst case transpiration and evaporation scenarios for both night and day. Worst case transpiration may be defined by the amount of water that needs to be removed from the air when plants are at the most dense phase of their life cycle (usually just before harvest when they have the most leaf surface area per unit volume), are at peak transpiration of their growth cycle (transpiring the most due to plant processes), and conditions are such that the vapor pressure deficit and other contributing factors promote evapotranspiration. The combination of these conditions results in the highest rate of evapotranspiration expected in the system.

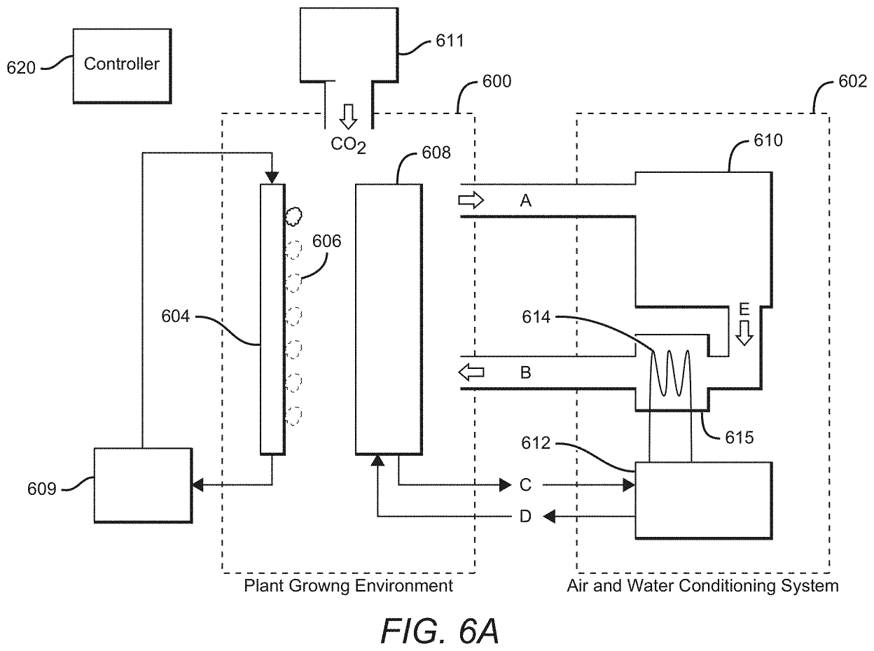

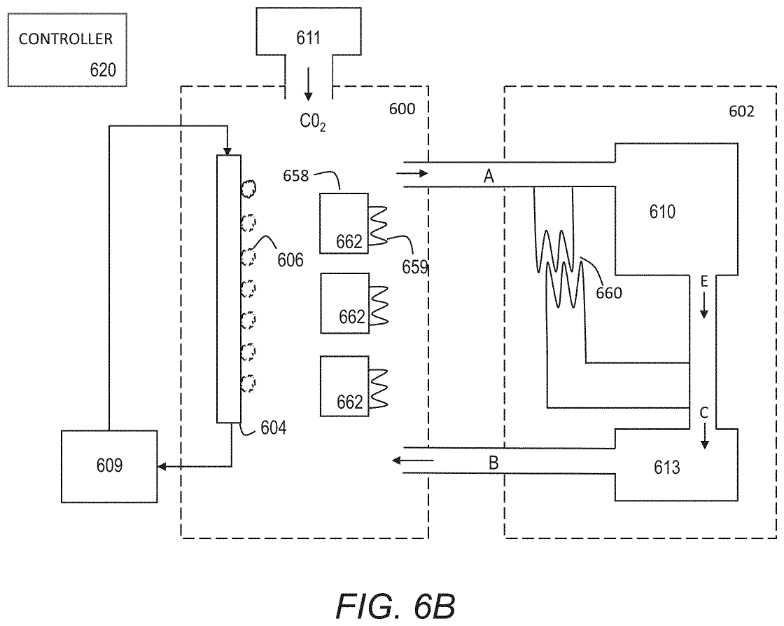

Control of sensible and latent loads, and optimizing systems for them, is an advantage of embodiments of the disclosure. FIG. 6A illustrates a system that uses a combination of highly efficient heat transfer devices to take advantage of the evapotranspirative cooling effect. According to embodiments of the disclosure, the system is divided into the plant growing environment 600 and an environmental conditioning system 602 for conditioning air and fluid (e.g., water) for the grow space. The plant growing environment 600 (e.g., grow chamber) includes a plant receptacle 604 holding plants 606 that exhibit transpiration, and lighting 608 that is cooled using a fluid (e.g., water) in communication with a fluid conditioning system 612, according to embodiments of the disclosure.

An irrigation pump 609 circulates water and nutrients through the plant receptacle 604. Carbon dioxide supply equipment 611 provides carbon dioxide to the plants. The irrigation pump 609 and carbon dioxide supply equipment 611 may be considered as part of the conditioning system 602, according to embodiments of the disclosure.

According to embodiments of the disclosure, the conditioning system 602 includes a dehumidifier 610, the fluid (e.g., water) conditioning system 612, and a heating coil 614 in heat exchanger 615. (The lighting 608, heating coil 614 and other heating and cooling elements that sensibly heat or cool the grow space may be considered to be sensible conditioning equipment.) The dehumidifier 610 receives from the grow space 600 return air A, having a temperature and relative humidity that depends on the plant transpiration rate and rate of evaporation from wet surfaces in the environment 600. The conditioning system 602 provides supply air B, having a temperature and relative humidity that is controlled to meet set points for desired operating conditions of the plants in the environment 600.

The fluid conditioning system 612 receives return fluid C from the fluid-cooled lighting 608. The fluid conditioning system 612 can control the fluid temperature by varying the fluid flow rate through the lighting 608. The fluid conditioning system 612 supplies to the fluid-cooled lighting 608 a supply fluid D, having a temperature that is controlled to meet sensible load set points for desired operating conditions of the plants in the environment 600.

Waste heat from the fluid passing through fluid conditioning system 612 may be provided to the heating coil 614 in the heat exchanger 615 to heat air E that is output from the dehumidifier 610. The air heated by the coil 614 is output as heated air B to the grow space 600.

FIG. 6B illustrates a system that uses a combination of highly efficient heat transfer devices to take advantage of the evapotranspirative cooling effect, according to embodiments of the disclosure. FIG. 6A is similar to FIG. 6B, but instead of or in addition to the lighting 608 in FIG. 6A, FIG. 6B includes lighting 658, such as air-cooled lighting, that is cooled by exchanging heat with air in the plant grow environment 600.

Lighting 658 may comprise one or more light modules 662 (as described below, e.g., light module 100) including, in some embodiments, a heat exchanger 659, such as heatsinks that facilitate heat transfer from lighting 658 to the air in the grow space 600. The heatsinks may be, e.g., aluminum blocks with fins to disperse heat into the air (for example, substrate 101), structures with heatpipes and layers of fins (for example, CPU heatsinks), or the like. The controller 620 may control the heat transfer by controlling factors such as light intensity, duration, and air flow through the lighting 658.

According to embodiments of the disclosure reflected in FIG. 6B, regardless of the efficiency of the lighting 658, substantially all (more than 75%) of the energy input to the lighting is converted either directly into heat or eventually converted into heat as light bounces around the grow space 600 and hits surfaces. The remainder of the energy represents the light conversion efficiency of the plants. According to embodiments of the disclosure, more than 80%, more than 85%, more than 90%, or more than 95% of the energy input to the lighting is converted into heat in the grow space (e.g., either directly into heat or eventually converted into heat as light bounces around the grow space 600 and hits surfaces). According to embodiments of the disclosure, only a very small portion of light is actually used by plants (˜5%).

As in FIG. 6A, the conditioning system 602 of FIG. 6B includes a dehumidifier 610. (The lighting 658 and any other heating and cooling elements 613 that sensibly heat or cool the grow space may be considered to be sensible conditioning equipment. Such elements may include electric resistance heating elements, hot and cold water coils, refrigerant loops.) The dehumidifier 610 receives from the grow space 600 return air A, having a temperature and relative humidity that depends on the plant transpiration rate, rate of evaporation from wet surfaces in the environment 600, and the heat transferred directly from the lighting 658 and thermal energy from the light.

The lighting 658 (e.g., light modules using LEDs) generates two types of heat. The first is heat generated, for example, directly at the LEDs, due to inefficiencies of converting electrical power to light. This type of heat, in some embodiments, corresponds to approximately 40% of the total power supplied to the lighting 658, depending on the light conversion efficiency of lighting 658. This heat contributes to the waste heat previously employed by the heat exchanger 615 in FIG. 6A. In the embodiments of FIG. 6B, that waste heat is directly transferred to the air in the grow space 600 (e.g., via heat exchanger 659). The second type of heat is from the absorption of light (generated by lighting 658) in the grow space 600. Almost all of the light eventually turns into heat in the grow space 600. This type of heat, in some embodiments, corresponds to approximately 60% of the total power supplied to the lighting 658.

The two types of heat originating with lighting 658 directly heats the air of the grow space 600, serving a function similar to the employment of waste heat from the lighting 608 to heat the grow space 600 of the system depicted in FIG. 6A. However, by directly heating the grow space instead of passing through a heat exchanger such as that of heat exchanger 615, lighting 658 reduces cost and complexity by avoiding the use of fluid-cooled elements such as element 612 in FIG. 6A. According to embodiments of the disclosure, the controller 620 may regulate the lighting 658 (or 608 in FIG. 6A) to help achieve the desired setpoint in the grow space 600, e.g., decrease the energy input to the lighting if it would otherwise contribute too much heat, or increase the energy input to the lighting if the heat would otherwise be insufficient to achieve the desired setpoint.

One difference between the systems of FIG. 6A and FIG. 6B is that the system of FIG. 6B need not include heating coil 614 and heat exchanger 615. However, FIG. 6B still includes a dehumidifier 610 to remove moisture from the grow space 600. The output air of a dehumidifier 610 is cooler than the input air, and it may still need to be reheated after dehumidification to maintain a desirable setpoint in the grow space 600.

System components commonly used in industry can be used to capture heat from the return air or from inefficiencies in the vapor compression cycle. For example, FIG. 6B illustrates use of a heat exchanger 660 (such as heat pipes, an air-to-air exchanger, or another heat exchanger that employs a controllable refrigerant) to precool the air A leaving the grow space and reheat the air E leaving the dehumidifier 610. According to embodiments of the disclosure, the reheated dehumidifier output air C may then be provided to sensible heating and cooling elements 613, which may add additional heat if the heat from heat exchanger 660 is not sufficient to achieve a desired setpoint in the grow space 600, or cool the heated, dehumidified air C if air C is too warm to achieve a desired setpoint. Elements 613 provide output air B back to the grow space 600. Alternatively, the heat exchanger 660 may transfer heat directly back into the grow space 600.

Supply air B has a temperature and relative humidity that is controlled to meet set points for desired operating conditions of the plants in the environment 600. A controller 620 may control all the elements of the conditioning system 602, according to embodiments of the disclosure. The controller 620 may receive sensed parameters from sensors distributed throughout the plant growing environment 600 and the air and water conditioning system 602, according to embodiments of the disclosure. Such sensors may include, for example, sensors that measure temperature, humidity, soil moisture, plant characteristics (e.g., size, shape, color), and irrigation flow rate. The controller 620 may also receive operating settings for those same parameters as well as others. The controller 620 may use the sensed parameters as feedback to instruct the conditioning system 602 to control environmental treatments (e.g., temperature, humidity) of the plant growing environment 600, according to embodiments of the disclosure. The controller 620 may employ machine learning or other predictive methods to adjust the treatments to achieve a desired objective relating to parameters such as ambient environmental conditions (e.g., temperature), energy usage, productivity, or plant product yield to energy use.

According to embodiments of the disclosure, the controller 620 may control evapotranspiration by controlling the following factors, whether alone or in any combination: irrigation, CO2 concentration, temperature, relative humidity, vapor pressure deficit, light intensity (e.g., based on daytime or nighttime condition), light wavelength (including electromagnetic radiation wavelength in the visible range and in the non-visible range, such as ultraviolet and infrared), light duration, light modulation (e.g., pulse width modulation), or air velocity, or by varying the supply of chemicals (e.g., hormones) that regulate transpiration. By increasing evapotranspiration, the controller 620 may cause a decrease in the sensible cooling load.

According to embodiments of the disclosure, the combination of mechanical equipment that is specified to remove water from the air and maintain the desired air temperature can vary widely, but there are some primary characteristics that they should typically include: (a) the equipment should be specified to remove an equivalent or larger amount of water than occurs during worst case transpiration and evaporation scenarios for both night and day; and (b) when heat is required to either warm the air or evaporate moisture, waste heat as a byproduct from other components in the system should be used. Waste heat may come from within the grow space (e.g., from lighting) or from the environmental control system 602 (e.g., from a compressor).

Referring to FIG. 6A and FIG. 6B, the environmental control system 602 may employ combinations of mechanical air-handling equipment to condition the control volume air. The desired outcome is precise control of conditions within the control volume and thus condition of the supply air. Cooling and heating coils, with a working fluid for heat transfer, are examples of equipment that can condition air. The working fluid within the coils can include, but is not limited to, water, water/fluid mixtures, and refrigerants. Sensible and latent heat is transferred between the air and the coils, and the working fluid transports that heat via a vapor-compression refrigeration cycle or other method. Desiccant dehumidification, enthalpy wheels, air-to-air heat exchangers, wrap-around heat pipes, air and water-side economizers, fluid coolers, chillers, condensing units, and fan coils are examples of other components that can be included with, or in conjunction with, the air handling equipment to provide system-level energy savings while conditioning the air.

The environmental control system 602 may employ Direct-Exchange (“DX”) equipment. DX equipment uses a vapor compression cycle to condition the air to a desired condition. At the evaporator of the DX equipment, the air is cooled to its saturation point and moisture condenses out, dehumidifying the air. Electronically controlled expansion valves and modulating hot-gas reheat are two features used with DX systems to incorporate the desired amount of heat back into the airstream, after dehumidification. Any heat that is not put back into the air will eventually be rejected, or sent to other energy recovery devices. Heat rejection can occur in a number of ways not limited to condensing units. Multiple rows of coils, variable speed fans, multiple vapor-compression circuits, air-side economization, and air bypasses are some of many ways that the DX unit can be configured to condition specific and varying loads with energy savings within one DX unit.

The environmental control system 602 may employ chilled water or chilled fluid air handling units that use a working fluid to cool, dehumidify, or heat the air to a desired condition. Chilled fluid can be provided by, but is not limited to, a chiller or fluid cooler. Heat-recovery chillers are one way that energy used in the cooling process can be re-used to heat the airstream back up to the desired condition. Chillers can be used in conjunction with other equipment that provides or removes heat, according to the embodiments of the disclosure. Boilers, solar heaters, heat pumps, the utilization of heat from lighting, and the utilization of heat from other equipment are just a few of the other ways that heat can be added to the airstream.

The environmental control system 602 may employ desiccant dehumidification either standing alone or in conjunction with other air-handling equipment to achieve a desired air condition with systems-level energy savings. Desiccants make use of a chemical that adsorbs moisture from the airstream. The chemical, or desiccants, used in desiccant dehumidifiers are able, when heated, to release the amount of moisture that was adsorbed to another fluid stream. In this process, heat is required to recharge the desiccants rather than to reheat air that has been cooled below the dew point. Although these systems are both energy efficient and have the ability to supply air at a low humidity, the capital cost may be high. One of several efficient applications of desiccant dehumidification is further dehumidifying air that has already been cooled by mechanical cooling equipment, prior to heating the air back up for delivery to the controlled environment.

The environmental control system 602 may employ energy wheels, enthalpy wheels or other air-to-air heat exchangers to further improve energy efficiency and recovery in air-handling units. A wrap-around heat pipe dehumidifier exchanges sensible heat of the outgoing airstream with the incoming airstream, with a cooling coil in-between. In this configuration, air that passes over the coil exchanges heat with incoming air, pre-cooling the incoming air and heating the outgoing air; the net effect of this is less cooling energy required at the coil. Total energy wheels and enthalpy wheels are just some of the heat exchange equipment that can be used in system-level optimization for energy and cost.

Carbon dioxide supply and control is also a component of the design. Control of carbon dioxide levels in the grow space affects evapotranspiration rate and components of plant growth. Carbon dioxide control, with other control variables such as, but not limited to, light intensity, vapor-pressure deficit, fan speed and airflow velocity control, and nutrient supply, are ways that the conditioning system 602 can control latent load for a controlled agriculture environment.

Lighting

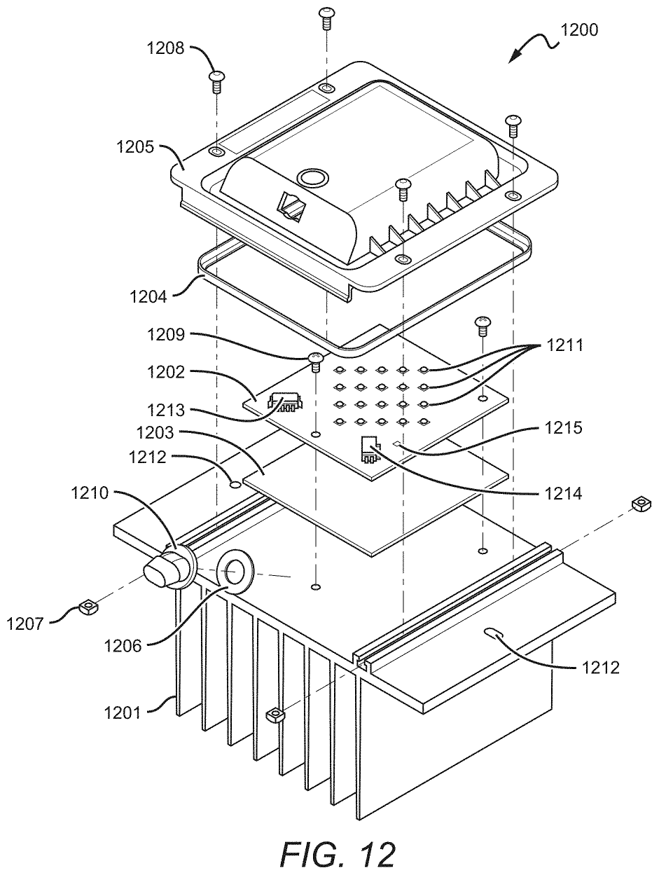

FIG. 12 shows an exemplary light module 1200. Light module 1200 comprises substrate 1201. In some embodiments, substrate 1201 includes fins to improve heat transfer from the substrate to the air in contact with the substrate. In some embodiments, light module 1200 comprises pc-board 1202 mounted to substrate 1201 using screws 1209. In some embodiments, one or more light emitting devices (e.g., light emitting diode (LED) modules) 1211 are mounted on pc-board 1202. In some embodiments, a thermal interface material 1203 is sandwiched between the pc-board 1202 and the substrate 1201 to improve transfer of heat, generated by the LED modules 1211, from the pc-board to the substrate 1201. In some embodiments, a protective cover 1205 is mounted on to the substrate 1201 using screws 1208 and nuts 1207. In some embodiments, a gasket 1204 is used to create a seal between the protective cover 1205 and substrate 1201. In some embodiments, a wire harness 1210 (partially shown) is connected to the pc-board 1202. In some embodiments, the wire harness 1210 passes through the protective cover 1205. In some embodiments, a wire harness gasket 1206 is used to create a seal between the wire harness 1210 and the protective cover 1205. In some embodiments, wire harness 1210 connects to one or both of connectors 1213 and 1214 on pc-board 1202.

In some embodiments, a separate heat sink unit with fins is mounted to the substrate to improve transfer of heat away from the substrate. In some embodiments, the substrate is made out of Aluminum. In some embodiments, the design of the fins may be selected based on the air flow around the light module 1200. In some embodiments, more than one pc-board is attached to the substrate (see FIG. 22, below). In some embodiments, the pc-board is made of Aluminum with one or more layers of a trace conductor, e.g., copper, to carry signals from the wire harness to the light emitting diode modules. In some embodiments, the thermal interface material 1203 is a thermal epoxy, a thermal grease, a thermal gap pad (e.g., acrylic, silicone), or thermal tape. In some embodiments, the pc-board may be omitted by forming traces on the substrate and mounting LED modules (described below) on the substrate.

In some embodiments, the pc-board includes one or more LED modules that each emit light in one or more portions of the light spectrum. In some embodiments, an LED module may emit light in the photosynthetically active regions of the light spectrum (e.g., between 400-700 nm). In some embodiments, the pc-board may include two or more types of LED modules with each type of LED module emitting light in a given region of the light spectrum. In some embodiments, the pc-board may include a first number of LED modules of the first type and another number of LED modules of another type. In some embodiments, the wavelength of the light output of an LED module may range over +/−20 nm, +/−10 nm, or +/−5 nm of a target wavelength (e.g., 450 nm, 530 nm, 660 nm, or 740 nm). In some embodiments, if different types LED modules are used, each type of LED module may be distributed over the pc-board to improve the light uniformity emitted from the light module. In some embodiments, the total light output from a single pc-board is between 50 W to 90 W, 60 W to 80 W, or 65 W to 75 W of light power (e.g., in the range of 400 nm to 800 nm). In some embodiments, a single pc-board in a light module is provided between 90 W to 130 W, 100 W to 120 W, or 105 W to 115 W of electrical power. In some embodiments, a single pc-board in a light module generates between 20 W to 60 W, 30 W to 50 W, or 35 W to 45 W of waste heat. In some embodiments, the photosyntheic light output from an array of light modules ranges between 600 umol/m2/s to 800 umol/m2/s (measured approximately 0.6 m from the plane of the array of light modules). This light output is characterized using units of umol/m2/s and is referenced as photosynthetic photon flux density (PPFD).

In some embodiments, the pc-board layout may be designed to accommodate the thermal load from LED modules. For example, some LED modules may generate more heat than other LED modules. For such LED modules, the pc-board layout may accommodate additional pads under the LED module in the trace conductor, e.g., copper, to improve heat transfer from the LED module to the pc-board. In another example, some LED modules may not include features (e.g., copper traces) to help move heat away from the LED module to pc-board. In such cases, the pc-board layout may be designed to include larger pads under such LED modules to improve heat transfer from the LED module to the pc-board.

In some embodiments, protective cover 1205 may incorporate one or more optical elements, e.g., lenses, to direct the light from the LED modules on the pc-board. In some embodiments, protective cover 1205 may protect the covered components from impact, debris, gases, moisture in the air, gaseous corrosive agents (e.g., peroxide vapor), liquids, or the like. In some embodiments, protective cover 1205 and gaskets 1204 and 1206 may enable simplified cleaning of the light module using compressed gas or liquid—e.g., without harming the enclosed components. If the light modules are used in a grow environment, the protective cover 1205 may get covered by splatter or debris that obstructs light originating from the LED modules from reaching the plants on grow towers. The light module, with protective cover 1205 in place, is easily cleaned using a sprayed liquid due to the seal crated by gaskets 1204 and 1206. In some embodiments, protective cover 1205 is made out of impact resistant plastic (e.g., polycarbonate) to prevent fracturing or shattering if impacted. This is particularly important in food production industries where typically metal detectors are used to inspect food quality and plastic detectors are not used.

In some embodiments, the wire harness includes conductors to provide power, e.g., 700 mA at 150 V DC, to drive the LED modules on the pc-board. In some embodiments, the wire harness 1210 includes conductors to permit data exchange from sensors or controllers on the pc-board. In some embodiments, a pc-board has one or more sensors (e.g., temperature sensor 1215 in FIG. 12) for monitoring the state of the pc-board or for monitoring the state of one or more LED modules on the pc-board. In some embodiments, a pc-board has one or more controllers that communicate with: (1) a light module controller, (2) a farm control system, or (3) controller 620. In some embodiments, a controller on the pc-board may: (1) control the current provided to an LED module on the pc-board (e.g., to control light output of the LED module, for example, to control light intensity or light spectrum), (2) communicate with a sensor (e.g., a temperature sensor) on the pc-board, or (3) control the current supplied by a power supply unit (e.g., by communicating with a light module controller controlling the power supply unit). In some embodiments, a light module controller may communicate with a sensor or controller using a data exchange protocol (e.g., Maxim 1-Wire) to exchange information with the sensor or controller connected to the light module controller in a daisy chain. In some embodiments, the pc-board includes two connectors to permit input and pass-through capability—permitting the daisy chaining of multiple pc-boards using wire harnesses from one pc-board to the next. For example, referring to FIG. 12, wire harness 1210 may connect a first wire segment from the power supply unit to connector 1213 on pc-board 1202 and connect a second wire segment to the next light module in the daisy chain via connector 1214 on pc-board 1202.

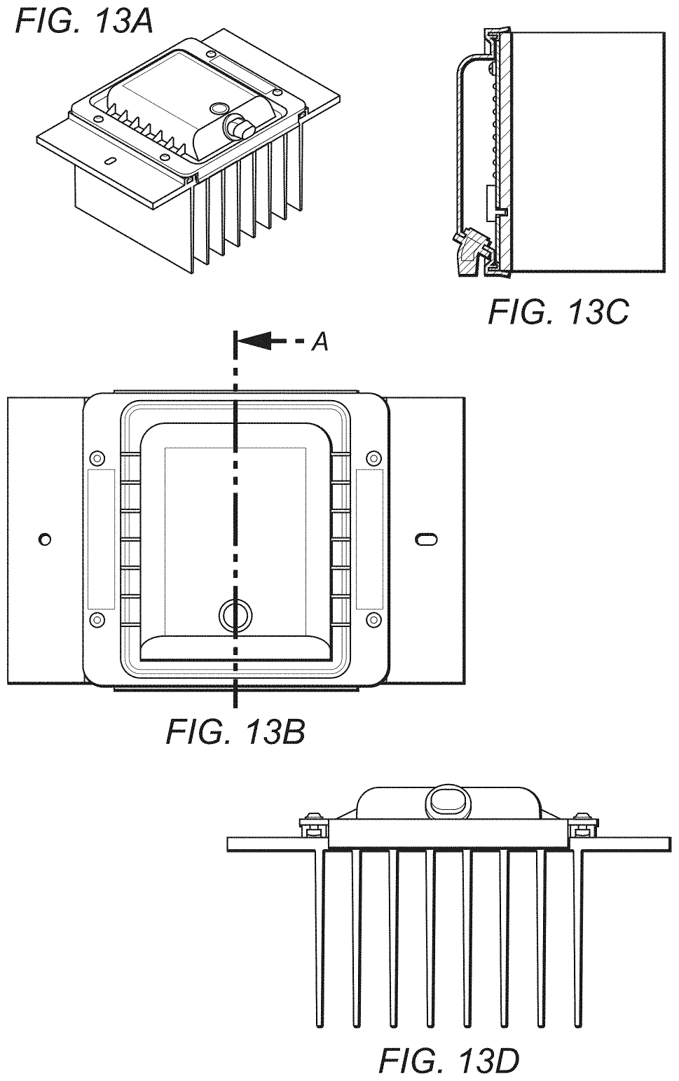

FIG. 13A shows a perspective view of the assembled light module 1200 from FIG. 12. FIG. 13B shows the top view of the assembled light module 1200 from FIG. 12. FIG. 13C shows a cross section view, along the line marked “A” in FIG. 13B, of the assembled light module 1200 from FIG. 12. FIG. 13D shows a side view of the assembled light module 1200 from FIG. 12.

As shown in FIG. 14A, a light module array is created by assembling two or more light modules (e.g., light module 1200 from FIG. 12, light module 1400 from FIG. 14A) together. Light module array may have 3 light modules arranged in a column (subset (column) of light module array 1401), 6 light modules arranged in a row (subset (row) of light module array 1401), a 2-dimensional array with 6 light modules arranged in a row repeated 3 times vertically (light module array 1401), a 2-dimensional array with 6 light modules arranged in a row repeated 24 times vertically (light module array 1402; light module array 1401 repeated 8 times vertically), a 2-dimensional array with 30 light modules arranged in a row repeated 24 times vertically (light module array 1403; light module array 1402 repeated 5 times horizontally; light module array 1401 repeated 5 times horizontally and 8 times vertically), or any arrangement of 2 or more light modules. In some embodiments, light module 1200 may be attached to a frame using screw holes 1212 (see FIG. 12) to form the light module array. In some embodiments, the light module array may be 5 m, 10 m, 15 m, 20 m, or larger wide (horizontally) and 5 m, 10 m, 15 m, 20 m, or larger tall (vertically). If needed, individual light modules may be replaced in the light module array—the ease of replacement of light modules permits higher operational “up” time for the “farm.”

FIG. 14B shows the light output (in PPFD) of an exemplary light module array which is 28 light modules wide and 18 light modules tall. FIG. 14C shows the light output (in PPFD) of an exemplary light module array which is 26 light modules wide and 12 light modules tall. As can be seen by comparing the light output uniformity shown in FIGS. 14B and 14C, improved light uniformity may be achieved by increasing the density of light modules in the light module array (e.g., lowering spacing between light modules, arranging light modules in a different pattern (e.g., hexagonal pattern compared to rectangular pattern in FIG. 14A)). In some embodiments, as shown in FIG. 14C, the light output uniformity in the x-direction (right/left in FIG. 14C, with y fixed) may be better, e.g., within 5%, than the light output uniformity in the y-direction (up/down in FIG. 14C, with x fixed), e.g., within 10%. In some embodiments, the light module array is designed to achieve a light output which is within 20%, 15%, 10%, 5% or 3% of a target light output level. In some embodiments, the light output is determined at a fixed distance from the light module array—the distance between the light module array and the grow towers (e.g., distance from the LED modules in light module to surface of grow towers) may be 200 mm, 400 mm, 600 mm, 800 mm or 1000 mm. In some embodiments, the light output may be controlled to vary across the light module array. For example, referring to FIG. 14B, the light output on the right side of the light module array may be set lower than the light output on the left side of the light module array if the grow towers start on the right side (with plants starting the growth phase) and move to the left side (with plants grown to full maturity and ready for harvesting)—because, for some species, larger plants can use more light.

In some embodiments, the light module array may include light modules facing two sides such that the light module array may be placed in between two rows of grow towers—see FIG. 14D. As shown in FIG. 14D, in some embodiments, light modules may be attached to a frame only on one side. As shown in FIG. 14D, in some embodiments, light modules may include fins (e.g., as part of a heat sink) that are angled relative to the substrate to permit tighter packing of light modules in the light module array (see FIG. 14F). In some embodiments, as shown in FIG. 14D, an edge of the light module array may include a reflector (e.g., bottom edge 1410, left edge 1420) to redirect light output from the edge light modules towards the inner, center area illuminated by the light module array. In some embodiments, the reflector helps to improve the light module array efficiency at an edge of the illuminated area (e.g., by directing photons from near-edge light modules towards the grow area that would otherwise not reach the grow area). FIG. 14E shows a zoomed-out view of the light module array shown in FIG. 14D. FIG. 14F shows a top view of two light modules 1450A and 1450B attached to spine 1430 and two light modules 1450C and 1450D attached to spine 1440. FIG. 14F also shows the left edge reflection 1420. Each light module 1450A, 1450B, 1450C, and 1450D directs light in the direction of the dashed arrow.

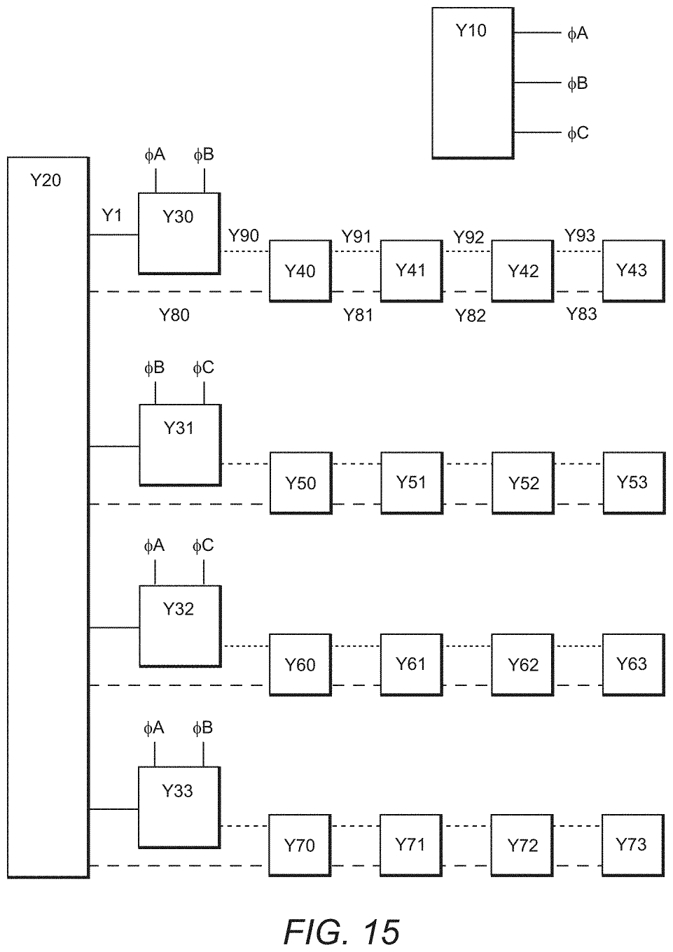

In some embodiments, a light module controller communicates with one or more power supply units with each power supply unit driving one or more light modules. FIG. 15 shows an exemplary schematic for a light module array. Light module controller Y20 communicates with power supply units Y30, Y31, Y32, and Y33 (e.g., Mean Well HVGC-1000A-H LED AC/DC driver). In some embodiments, a power supply unit is powered using AC power and provides DC power to a light module. In the embodiment shown in FIG. 15, power supply panel Y10 receives AC power (e.g., 480V AC 3-phase with Phase A, B, and C). Power supply unit Y30 is powered by phase A and B from power supply panel Y10. Power supply unit Y31 is powered by phase B and C from power supply panel Y10. Power supply unit Y32 is powered by phase A and C from power supply panel Y10. Power supply unit Y33 is powered by phase A and B from power supply panel Y10.

Light module controller Y20 communicates with power supply unit Y30 using link Y1 to control the output of the power supply unit Y30. The output of the power supply unit is used to drive one or more light modules. In some embodiments, light module controller may provide a signal (e.g., 0-10 V PWM signal via link Y1) to power supply unit Y30 to dim the light modules driven by power supply unit Y30. For example, in the embodiment shown in FIG. 15, power supply Y30 drives light modules Y40, Y41, Y42, and Y43. In some embodiments, the output of a power supply unit is connected to a first light module within a string of daisy-chained light modules, and each light module in the daisy-chain is connected to at least one other light module in the daisy-chain. For example, the output of power supply unit Y30 is connected to light module Y40 using link Y90 (e.g., via connector 1213 on light module Y40). Light module Y40/Y41/Y42 supplies power to light module Y41/Y42/Y43 using link Y91/Y92/Y93, respectively. In some embodiments, power supply unit may power light modules Y40, Y41, Y42, and Y43 using a non-daisy chain configuration (e.g., hub and spoke distribution, not shown).

In some embodiments, the light module controller communicates with a sensors or controller on a light module connected to the light module controller. As shown in FIG. 15, light module controller Y20 communicates with light modules Y40, Y41, Y42, and Y43 using a daisy chained communication links Y80 (e.g., via connector 1213 on light module Y40), Y81, Y82, and Y83. In some embodiments, links from one light module to another light module (e.g., links Y80 and Y90, links Y81 and Y91, links Y82 and Y92, links Y83 and 93) in the daisy chain may be combined into a single bundle of wires (e.g., links Y80 and Y90 connect to connector 1213 on light module Y40, links Y81 and Y91 connect to connector 1214 on light module Y40 and connect to connector 1213 on light module Y41). In some embodiments, each light module includes a sensor (e.g., temperature sensor) with a unique ID, and light module controller may receive the sensor's unique ID and sensor data (e.g., sensed temperature) and associate the sensor data with the identified light module based on the sensor's unique ID. In some embodiments, light module controller may communicate with a sensor or controller on a light module using a non-daisy chain configuration (e.g., hub and spoke distribution, not shown).

In some embodiments, the light module controller Y20 may send information related to the status of a connected power supply unit or the status of a connected light module to a farm control system or controller 620. In some embodiments, the light module controller Y20 is connected to a network gateway through a network switch. Information is exchanged between the light module controller Y20 and the farm control system or controller 620 using the network gateway.

In some embodiments, light module controller (e.g., light module controller Y20) comprises one or more processors (e.g., ARM SoC), one or more memories, and instructions stored on non-transitory computer readable media. The instructions, when executed by a processor, permit the light module controller to communicate with a power supply unit (e.g., provide a signal to control power supply unit output) or a light module (e.g., communicate with a sensor or controller on the light module). In some embodiments, light module controller (e.g., light module controller Y20) comprises a display or an indicator (e.g., LED indicator). The display or indicator may be used to indicate the status of: (1) the light module controller (e.g., list of connected power supply units, list of connected light modules), (2) a connected power supply unit (e.g., current output state), or (3) a connected light module (e.g., current temperature of temperature sensor on a pc-board in light module). In some embodiments, light module controller (e.g., light module controller Y20) comprises one or more communication interfaces (e.g., USB, Bluetooth, IRDA, Ethernet, WiFi) to communicate with other devices (e.g., sensors in the grow space, farm control system, controller 620, etc.). In some embodiment, light module controller (e.g., light module controller Y20) may provide power to other devices (e.g., sensors in the grow space). In some embodiments, light module controller (e.g., light module controller Y20) may be implemented with a computer system like that of computer system 800.

In some embodiments, the light module controller controls the light output of the light modules (e.g., based on an illumination schedule (e.g., “day”/“night” schedule) for the grow towers). In some embodiments, the light module controller controls the spectrum of the light output of the light module (e.g., selectively turning on or off LED modules corresponding to certain wavelengths). In some embodiments, the light module controller controls the intensity of the light module (e.g., using a 0-10 V PWM signal connected to a power supply unit driving the light module). In some embodiments, the light module controller controls the current or voltage output from a power supply unit driving a light module (e.g., to control the light output of the light module). In some embodiments, some or all of the functions of the light module controller may be performed by the farm control system or controller 620. In some embodiments, the light module controller may receive instructions from the farm control system or controller 620 to perform some or all of the functions described herein as performed by the light module controller. In some embodiments, the farm control system may instruct controller 620, which, in response thereto, may instruct the light module controller.

In some embodiments, the light module controller processes information from a connected light module and provides alerts to: (1) users via an indicator (e.g., LED or display on the light control module), (2) the farm control system, or (3) the controller 620. In some embodiments, an alert indicates a performance issue with a light module (e.g., indicating that a given light module needs to be serviced or replaced). For example, the light module controller may process information from a temperature sensor on a pc-board of a light module and provide an indication of the light module temperature to the farm control system or controller 620. In some embodiments, the farm control system or controller 620 may determine, based on the indication of the light module temperature, that the light module needs to be serviced or replaced. In some embodiments, the light module controller may make the determination, based on the indication of the light module temperature, that the light module needs to be serviced or replaced instead of the farm control system or controller 620 making the determination.

For example, a light module temperature lower than neighboring light module temperatures may indicate that one or more light modules have failed on the given light module—suggesting that the light module needs to be repaired or replaced. In another example, a light module temperature higher than light module temperatures in other parts of the light module array may indicate: (1) inadequate cooling of the given light module—suggesting that the air flow for the given light module needs to be modified, (2) progressive failure of the thermal interface material, (3) blockage or clouding of the cover leading to increased reflected light from the cover back to the light module, or (4) blockage or fouling of the light module heatsink.

In some embodiments, the status of light modules may be monitored. For example, in some embodiments, a temperature sensor is mounted to the pc-board and the temperature measured by the temperature sensor is monitored via the wire harness. The ID of the temperature sensor on a specific pc-board in a given light module may be used to track the temperature of the pc-board in the light module. If the temperature of a given light module is higher than the temperature of other light modules in the light module array (e.g., due to inadequate air flow/cooling), the light module may have reduced photon production efficiency. If the temperature of a given light module is lower than the temperature of other light modules in the light module array (e.g., due to failure of one or more LED modules), the light module may need to be replaced to provide the required light uniformity in the grow area. Generally, differences in temperature between light modules in a light module array may provide an indication of differences in light output across the light module array. In some embodiments, a set of light modules may be driven in constant current mode. In such instances, a failure in a given light module may lead to a brightening (and accompanying higher temperature) in the remaining light modules. Measurement of light module temperature may be used to debug such types of failures in a light module array.

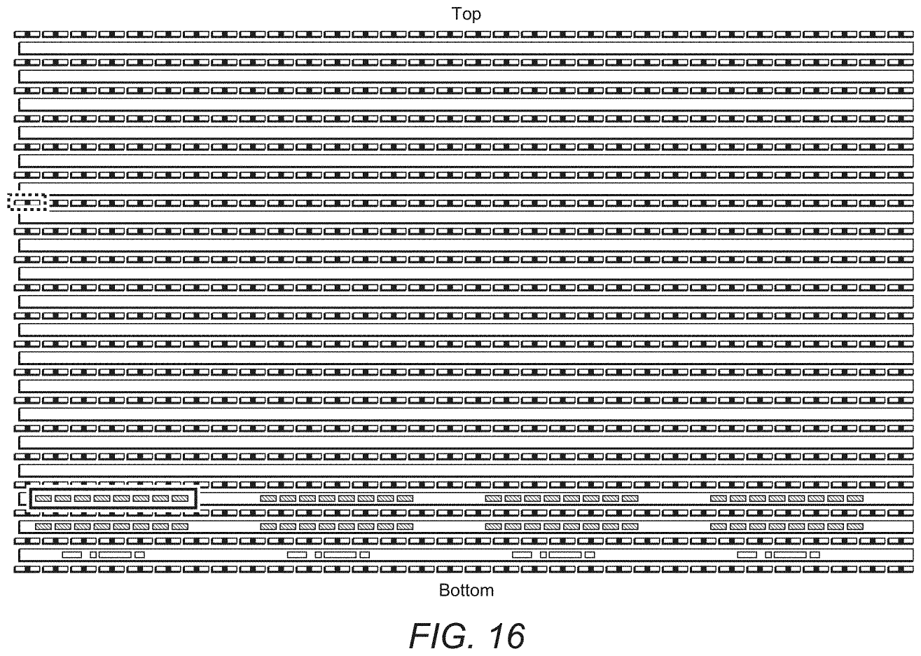

FIG. 16 shows a representation of light module array with power supply units mounted near the bottom of the light module array frame. A single light module in the light module array is marked off by the dotted box shown in FIG. 16. Eight power supply units are marked off by the box shown in FIG. 16. The light module array in FIG. 16 has 32 vertically aligned columns and 20 horizontally aligned rows of light modules (320 total light modules). In some embodiments, the power supply units, light module controllers and other components are mounted near the bottom of the light module array to permit easier installation and servicing. In some embodiments, the frame used to mount light modules in a light module array may also be used to mount other equipment for use in the farm (e.g., carrier for a person to be carried to the top of the frame).

An exemplary light module array comprises 5 light module controllers, 10 power supply units, and 300 light modules. Each light module controller communicates with the 10 power supply units. Each power supply unit drives 6 light modules. Each of the light module controllers also communicates with a sensor or controller on each of the light modules. Two of such light module arrays may be arranged as illustrated in FIG. 14F to illuminate two rows of grow towers facing each light module array.

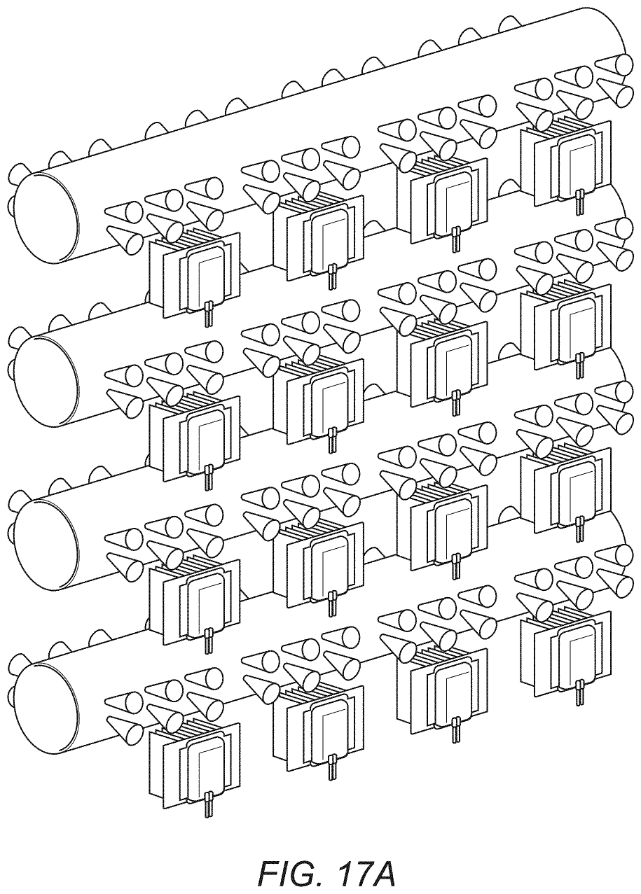

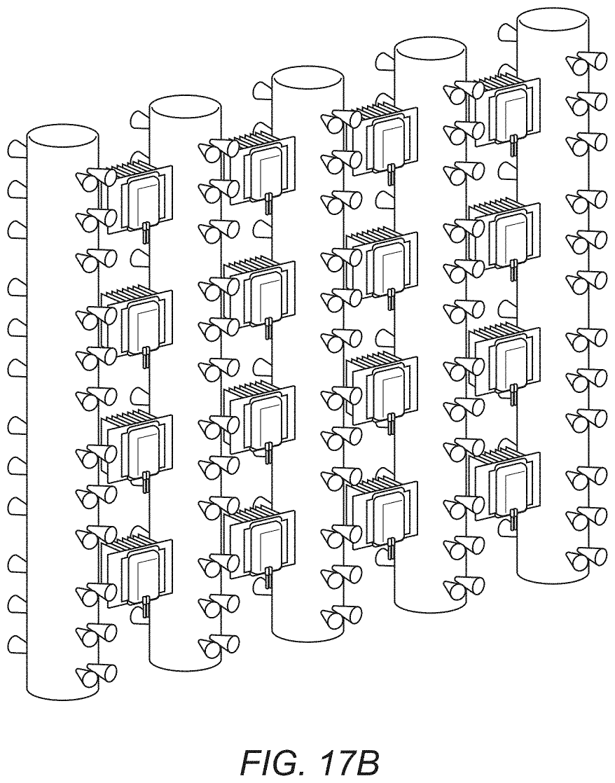

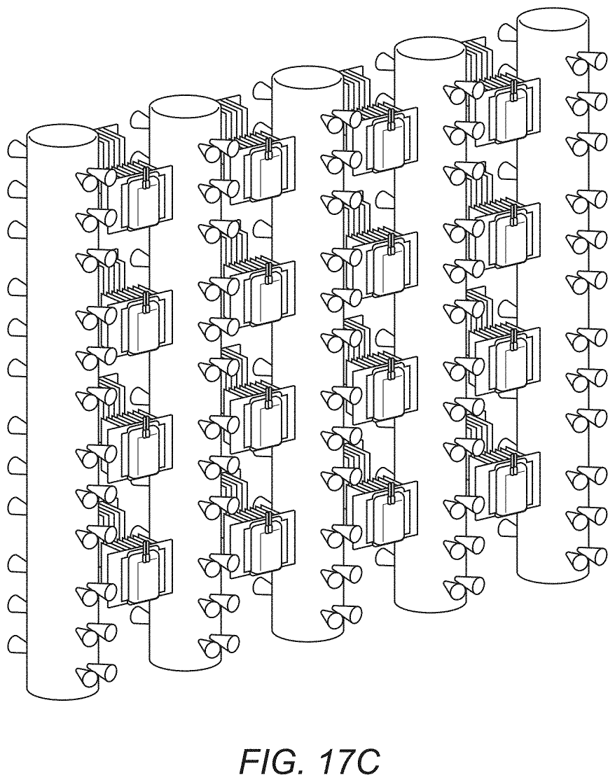

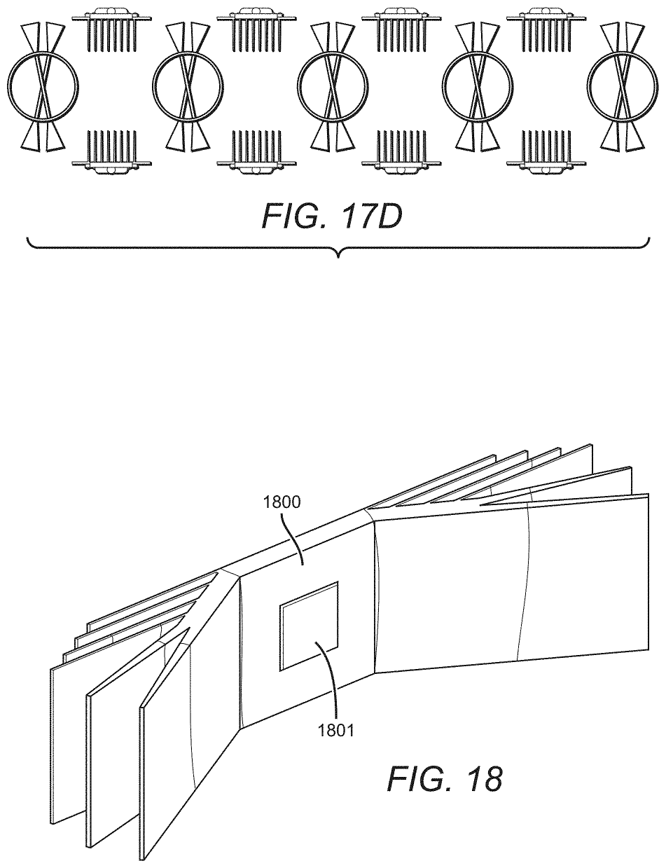

In some embodiments, as shown in FIGS. 17A-17D, ducts may be integrated with the light module array to provide air flow near the light modules. In some embodiments, air flow from the ducts disrupts the chimney effect of hot air (local air heated by waste heat generated by the light module when the light module is “on”) rising from the light module due to natural convection. In some embodiments, the air from the ducts permits mixing of the hot air (local air heated by waste heat generated by the light module when the light module is “on”) near the light modules with air in the surrounding environment. In some embodiments, the ducts may provide between 1 CFM to 4 CFM, 1.5 CFM to 3.5 CFM, or 2 CFM to 3 CFM of air for each light module. In some embodiments, a portion of the flow (air B in FIG. 6B) from the conditioning system 602 is used to provide air flow near the light modules (e.g., via air ducts shown in FIGS. 17A-D). In some embodiments, up to 10%, 20%, or 30% of the flow (air B in FIG. 6B) from the conditioning system 602 may be used to provide air flow near the light modules.

As shown in FIG. 17A, in some embodiments, air ducts run horizontally relative to the light module array and funnels direct air flow near the light modules. As shown in FIG. 17B, in some embodiments, air ducts run vertically relative to the light module array and funnels direct air flow near the light modules. In some embodiments, as shown in FIG. 17C, funnels connected to the air ducts direct air flow to two light module arrays directing light in opposite directions. FIG. 17D shows a top view of an exemplary arrangement of air ducts, funnels, and two light module arrays.

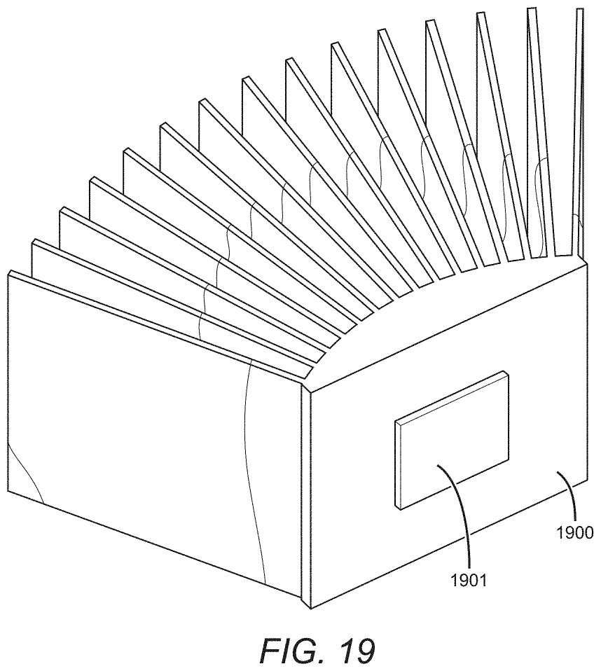

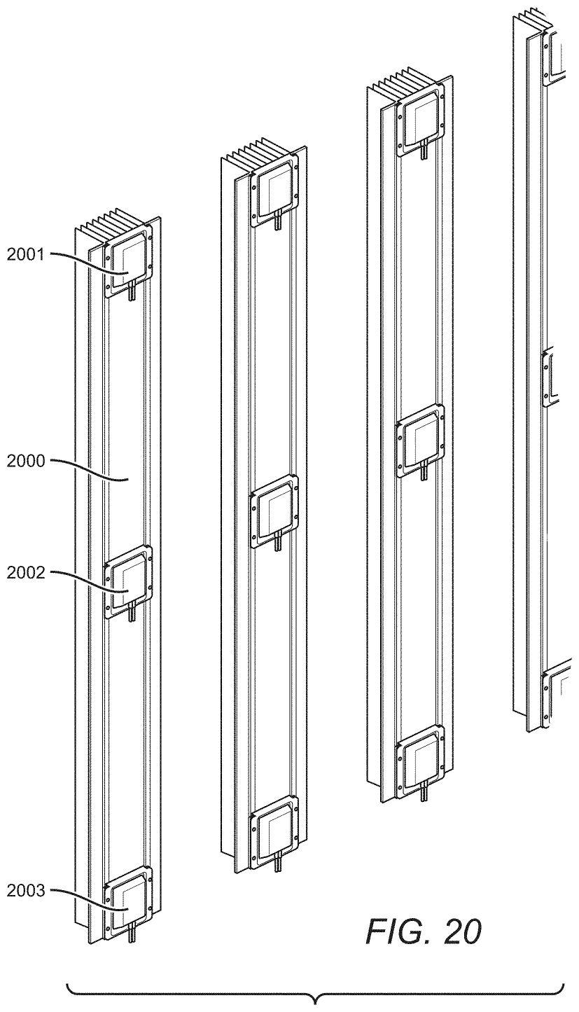

As shown in FIG. 18, in some embodiments, a light module may include a substrate 1800 with fins that are arranged to the side of the pc-board 1801. As shown in FIG. 19, in some embodiments, a light module may include a substrate 1900 with fins that are arranged at different angles relative to the pc-board 1901. As shown in FIG. 20, in some embodiments, a light module may include a substrate 2000 with more than one pc-board 2001, 2002, 2003.

Machine Learning

Embodiments of the disclosure may apply machine learning (“ML”) techniques to learn the relationship between the given parameters (e.g., environmental conditions such as temperature, humidity) and observed outcomes (e.g., experimental data concerning yield and energy consumption). In this framework, embodiments may use standard ML models, e.g. Decision Trees, to determine feature importance. In general, machine learning may be described as the optimization of performance criteria, e.g., parameters, techniques or other features, in the performance of an informational task (such as classification or regression) using a limited number of examples of labeled data, and then performing the same task on unknown data. In supervised machine learning such as an approach employing linear regression, the machine (e.g., a computing device) learns, for example, by identifying patterns, categories, statistical relationships, or other attributes exhibited by training data. The result of the learning is then used to predict whether new data will exhibit the same patterns, categories, statistical relationships or other attributes.

Embodiments of this disclosure may employ unsupervised machine learning. Alternatively, some embodiments may employ semi-supervised machine learning, using a small amount of labeled data and a large amount of unlabeled data. Embodiments may also employ feature selection to select the subset of the most relevant features to optimize performance of the machine learning model. Depending upon the type of machine learning approach selected, as alternatives or in addition to linear regression, embodiments may employ for example, logistic regression, neural networks, support vector machines (SVMs), decision trees, hidden Markov models, Bayesian networks, Gram Schmidt, reinforcement-based learning, cluster-based learning including hierarchical clustering, genetic algorithms, and any other suitable learning machines known in the art. In particular, embodiments may employ logistic regression to provide probabilities of classification along with the classifications themselves.

Embodiments may employ graphics processing unit (GPU) or Tensor processing units (TPU) accelerated architectures that have found increasing popularity in performing machine learning tasks, particularly in the form known as deep neural networks (DNN). Embodiments of the disclosure may employ GPU-based machine learning, such as that described in GPU-Based Deep Learning Inference: A Performance and Power Analysis, NVidia Whitepaper, November 2015, Dahl, et al., which is incorporated by reference in its entirety herein.

Computer System Implementation

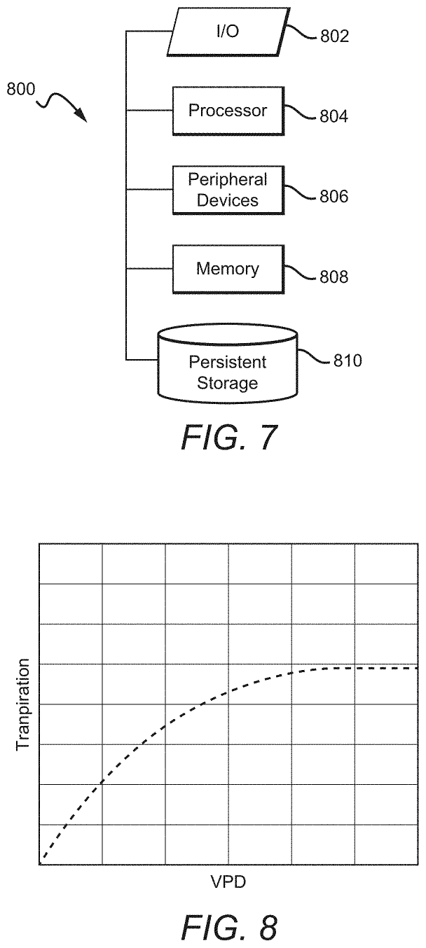

FIG. 7 illustrates an example of a computer system 800 that may be used to execute program code stored in a non-transitory computer readable medium (e.g., memory) in accordance with embodiments of the disclosure. The computer system includes an input/output subsystem 802, which may be used to interface with human users or other computer systems depending upon the application. The I/O subsystem 802 may include, e.g., a keyboard, mouse, graphical user interface, touchscreen, or other interfaces for input, and, e.g., an LED or other flat screen display, or other interfaces for output, including application program interfaces (APIs). Other elements of embodiments of the disclosure, such as the controller 620, may be implemented with a computer system like that of computer system 800.

Program code may be stored in non-transitory media such as persistent storage in secondary memory 810 or main memory 808 or both. Main memory 808 may include volatile memory such as random access memory (RAM) or non-volatile memory such as read only memory (ROM), as well as different levels of cache memory for faster access to instructions and data. Secondary memory may include persistent storage such as solid state drives, hard disk drives or optical disks. One or more processors 804 reads program code from one or more non-transitory media and executes the code to enable the computer system to accomplish the methods performed by the embodiments herein. Those skilled in the art will understand that the processor(s) may ingest source code, and interpret or compile the source code into machine code that is understandable at the hardware gate level of the processor(s) 804. The processor(s) 804 may include graphics processing units (GPUs) for handling computationally intensive tasks.

The processor(s) 804 may communicate with external networks via one or more communications interfaces 807, such as a network interface card, WiFi transceiver, etc. A bus 805 communicatively couples the I/O subsystem 802, the processor(s) 804, peripheral devices 806, communications interfaces 807, memory 808, and persistent storage 810. Embodiments of the disclosure are not limited to this representative architecture. Alternative embodiments may employ different arrangements and types of components, e.g., separate buses for input-output components and memory subsystems.

Those skilled in the art will understand that some or all of the elements of embodiments of the disclosure, and their accompanying operations, may be implemented wholly or partially by one or more computer systems including one or more processors and one or more memory systems like those of computer system 800. In particular, the elements of automated systems or devices described herein may be computer-implemented. Some elements and functionality may be implemented locally and others may be implemented in a distributed fashion over a network through different servers, e.g., in client-server fashion, for example.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive “or” in the manner of “and/or.”

Those skilled in the art will recognize that, in some embodiments, some of the operations described herein may be performed by human implementation, or through a combination of automated and manual means. When an operation is not fully automated, appropriate components of embodiments of the disclosure may, for example, receive the results of human performance of the operations rather than generate results through its own operational capabilities.

All references, articles, publications, patents, patent publications, and patent applications cited herein are incorporated by reference in their entireties for all purposes to the extent they are not inconsistent with embodiments of the disclosure expressly described herein. However, mention of any reference, article, publication, patent, patent publication, and patent application cited herein is not, and should not be taken as an acknowledgment or any form of suggestion that they constitute valid prior art or form part of the common general knowledge in any country in the world, or that they are disclose essential matter.

In the claims below, a claim n reciting “any one of the preceding claims starting with claim x,” shall refer to any one of the claims starting with claim x and ending with the immediately preceding claim (claim n-1). For example, claim 35 reciting “The system of any one of the preceding claims starting with claim 28” refers to the system of any one of claims 28-34.

### EMBODIMENTS OF THE DISCLOSURE

### Set 1: Latent and Sensible Heat Control

1. A control system for controlling latent and sensible loads in a grow space, the system comprising:
   one or more memories storing instructions;
   one or more processors, operatively coupled to the one or more memories, that execute the instructions to:
   a. control one or more environmental conditions to control a latent load in the grow space,
      i. wherein density of a plurality of plant receptacles in the grow space is such that, when plants are held in the plurality of plant receptacles, evapotranspiration contributes to the latent load so that the latent load exceeds a sensible load; and
   b. control one or more environmental conditions to control the sensible load to provide heat to at least partially offset the latent load,
      i. wherein substantially all of the energy input to lighting in the grow space has the effect of warming the air in the grow space.
2. The system of embodiment 1, comprising: a dehumidifier for dehumidifying input air from the grow space; and a heat exchanger for transferring heat extracted by the heat exchanger from the input air to dehumidified air at the output of the dehumidifier.
3. The system of any one of the preceding embodiments, comprising: a dehumidifier for dehumidifying input air from the grow space; and a heat exchanger for transferring heat extracted by the heat exchanger from the input air to air in the grow space.
4. The system of any one of the preceding embodiments, wherein more than 90% of the energy input to lighting in the grow space has the effect of warming the air in the grow space.
5. The system of any one of the preceding embodiments, wherein more than 95% of the energy input to lighting in the grow space has the effect of warming the air in the grow space.
6. The system of any one of the preceding embodiments, wherein at least one of the sensible load or the latent load is controlled to achieve at least one desired condition.
7. The system of embodiment 6, wherein the at least one desired condition is a desired ambient temperature, a desired energy consumption, a desired productivity, or a desired ratio of plant product yield to energy use.
8. The system of embodiment 6, wherein controlling the latent load and controlling the sensible load employ machine learning to achieve the desired condition.
9. The system of any one of the preceding embodiments, wherein evapotranspiration is controlled by controlling at least one of irrigation or CO2 concentration, or by supplying chemicals that regulate transpiration.
10. The system of any one of the preceding embodiments, wherein evapotranspiration is controlled by controlling at least one of temperature, relative humidity, vapor pressure deficit, light intensity, light wavelength, light duration, or air velocity, or by varying lighting based on daytime or nighttime condition.
11. The system of any one of the preceding embodiments, wherein the latent load is controlled within a control volume to achieve at least one desired condition within the control volume.
12. The system of embodiment 11, wherein the control volume includes lighting and the plurality of plant receptacles.
13. The system of embodiment 11, wherein controlling the latent load comprises receiving sensor signals representing characteristics of at least one plant in the control volume.
14. The system of any one of the preceding embodiments, wherein the one or more memories store instructions, that when executed by at least one of the one or more processors, cause the system to employ waste heat to warm the air or evaporate moisture in the grow space.
15. The system of embodiment 14, wherein lighting in the grow space provides the waste heat.
16. The system of embodiment 15, wherein controlling the sensible load comprises cooling the lighting to control the waste heat.
17. The system of any one of the preceding embodiments, comprising fluid-cooled lighting in the grow space, a dehumidifier for dehumidifying the grow space, and a heat exchanger, wherein the heat exchanger employs waste heat from the lighting to heat air output from the dehumidifier and provide the heated air to the grow space.
18. The system of any one of the preceding embodiments, comprising increasing evapotranspiration to decrease a sensible cooling load.
19. The system of any one of the preceding embodiments, wherein at least one of the one or more memories store instructions, that, when executed by one or more processors, cause the system to dehumidify the grow space or sensibly heat or cool the grow space.
20. The system of any one of the preceding embodiments, wherein the grow space is an enclosed grow space.
21. The system of any one of the preceding embodiments, wherein controlling the one or more environmental conditions comprises setting the one or more environmental conditions to one or more environmental setpoints that are determined using a physics based model.
22. The system of embodiment 21, wherein the one or more environmental setpoints are also determined using an empirically based model.
23. A method for controlling latent and sensible loads in a grow space, the method comprising:
   a. controlling one or more environmental conditions to control a latent load in the grow space,
      i. wherein density of a plurality of plant receptacles in the grow space is such that, when plants are held in the plurality of plant receptacles, evapotranspiration contributes to the latent load so that the latent load exceeds a sensible load; and
   b. controlling one or more environmental conditions to control the sensible load to provide heat to at least partially offset the latent load,
      i. wherein substantially all of the energy input to lighting in the grow space has the effect of warming the air in the grow space.
24. The method of any one of the preceding embodiments starting with embodiment 23, further comprising dehumidifying input air from the grow space, and transferring heat extracted from the input air to the dehumidified air.
25. The method of any one of the preceding embodiments starting with embodiment 23, further comprising dehumidifying input air from the grow space, and transferring heat extracted from the input air to air in the grow space.
26. The method of any one of the preceding embodiments starting with embodiment 23, wherein more than 90% of the energy input to lighting in the grow space has the effect of warming the air in the grow space.
27. The system of any one of the preceding embodiments starting with embodiment 23, wherein more than 95% of the energy input to lighting in the grow space has the effect of warming the air in the grow space.
28. The method of any one of the preceding embodiments starting with embodiment 23, wherein at least one of the sensible load or the latent load is controlled to achieve at least one desired condition.
29. The method of embodiment 28, wherein the at least one desired condition is a desired ambient temperature, a desired energy consumption, a desired productivity, or a desired ratio of plant product yield to energy use.
30. The method of embodiment 28, wherein the controlling the latent load and controlling the sensible load employ machine learning to achieve the desired condition.
31. The method of any one of the preceding embodiments starting with embodiment 23, wherein evapotranspiration is controlled by controlling at least one of irrigation or CO2 concentration, or by supplying chemicals that regulate transpiration.
32. The method of any one of the preceding embodiments starting with embodiment 23, wherein evapotranspiration is controlled by controlling by at least one of temperature, relative humidity, vapor pressure deficit, light intensity, light wavelength, light duration, or air velocity, or by varying lighting based on daytime or nighttime condition.
33. The method of any one of the preceding embodiments starting with embodiment 23, wherein the latent load is controlled within a control volume to achieve the at least one desired condition within the control volume.
34. The method of embodiment 33, wherein the control volume includes lighting and the plurality of plant receptacles.
35. The method of embodiment 33, wherein controlling the latent load comprises receiving sensor signals representing characteristics of at least one plant in the control volume.
36. The method of any one of the preceding embodiments starting with embodiment 23, further comprising employing waste heat to warm the air or evaporate moisture in the grow space.
37. The method of embodiment 36, wherein lighting in the grow space provides the waste heat.
38. The method of embodiment 37, wherein controlling the sensible load comprises cooling the lighting to control the waste heat.
39. The method of any one of the preceding embodiments starting with embodiment 23, wherein the grow space includes fluid-cooled lighting, and a conditioning system includes a dehumidifier and a heat exchanger, the method comprising:
   using the heat exchanger, heating air output from the dehumidifier using waste heat from the lighting; and
   providing the heated air to the grow space.
40. The method of any one of the preceding embodiments starting with embodiment 23, comprising increasing evapotranspiration to decrease a sensible cooling load.
41. The method of any one of the preceding embodiments starting with embodiment 23, further comprising dehumidifying the grow space or sensibly heating or cooling the grow space.
42. The method of any one of the preceding embodiments starting with embodiment 23, wherein the grow space is an enclosed grow space.
43. The method of any one of the preceding embodiments starting with embodiment 23, wherein controlling the one or more environmental conditions comprises setting the one or more environmental conditions to one or more environmental setpoints that are determined using a physics based model.
44. The method of embodiment 43, wherein the one or more environmental setpoints are also determined using an empirically based model.
45. One or more non-transitory computer-readable media storing instructions for controlling latent and sensible loads in a grow space, wherein the instructions, when executed by one or more computing devices, cause at least one of the one or more computing devices to:
   a. control one or more environmental conditions to control a latent load in the grow space,
      i. wherein density of a plurality of plant receptacles in the grow space is such that, when plants are held in the plurality of plant receptacles, evapotranspiration contributes to the latent load so that the latent load exceeds a sensible load; and
   b. control one or more environmental conditions to control the sensible load to provide heat to at least partially offset the latent load,
      i. wherein substantially all of the energy input to lighting in the grow space has the effect of warming the air in the grow space.
46. The one or more computer-readable media of embodiment 45, wherein at least one of the one or more computer-readable media store instructions, that, when executed, cause dehumidification of input air from the grow space, and transferring of heat extracted by the heat exchanger from the input air to dehumidified air at the output of the dehumidifier.
47. The one or more computer-readable media of any one of the preceding embodiments starting with embodiment 45, wherein at least one of the one or more computer-readable media store instructions, that, when executed, cause dehumidification of input air from the grow space, and transferring of heat extracted by the heat exchanger from the input air to air in the grow space.
48. The one or more computer-readable media of any one of the preceding embodiments starting with embodiment 45, wherein more than 90% of the energy input to lighting in the grow space has the effect of warming the air in the grow space.
49. The one or more computer-readable media of any one of the preceding embodiments starting with embodiment 45, wherein more than 95% of the energy input to lighting in the grow space has the effect of warming the air in the grow space.
50. The one or more computer-readable media of any one of the preceding embodiments starting with embodiment 45, wherein at least one of the sensible load or the latent load is controlled to achieve at least one desired condition.
51. The one or more computer-readable media of embodiment 50, wherein the at least one desired condition is a desired ambient temperature, a desired energy consumption, a desired productivity, or a desired ratio of plant product yield to energy use.
52. The one or more computer-readable media of embodiment 50, wherein controlling the latent load and controlling the sensible load employ machine learning to achieve the desired condition.
53. The one or more computer-readable media of any one of the preceding embodiments starting with embodiment 45, wherein evapotranspiration is controlled by controlling at least one of irrigation or CO2 concentration, or by supplying chemicals that regulate transpiration.
54. The one or more computer-readable media of any one of the preceding embodiments starting with embodiment 45, wherein evapotranspiration is controlled by controlling at least one of temperature, relative humidity, vapor pressure deficit, light intensity, light wavelength, light duration, or air velocity, or by varying lighting based on daytime or nighttime condition.
55. The one or more computer-readable media of any one of the preceding embodiments starting with embodiment 45, wherein the latent load is controlled within a control volume to achieve at least one desired condition within the control volume.
56. The one or more computer-readable media of embodiment 55, wherein the control volume includes lighting and the plurality of plant receptacles.
57. The one or more computer-readable media of embodiment 55, wherein controlling the latent load comprises receiving sensor signals representing characteristics of at least one plant in the control volume.
58. The one or more computer-readable media of any one of the preceding embodiments starting with embodiment 45, wherein at least one of the one or more computer-readable media store instructions, that, when executed by one or more computing devices, cause at least one of the one or more computing devices to cause waste heat to be used to warm the air or evaporate moisture in the grow space.
59. The one or more computer-readable media of embodiment 58, wherein lighting in the grow space provides the waste heat.
60. The one or more computer-readable media of embodiment 59, wherein controlling the sensible load comprises cooling the lighting to control the waste heat.
61. The one or more computer-readable media of any one of the preceding embodiments starting with embodiment 45, wherein the grow space includes fluid-cooled lighting, a conditioning system includes a dehumidifier and a heat exchanger, and the heat exchanger employs waste heat from the lighting to heat air output from the dehumidifier and provide the heated air to the grow space.
62. The one or more computer-readable media of any one of the preceding embodiments starting with embodiment 45, wherein at least one of the one or more computer-readable media store instructions, that, when executed by one or more computing devices, cause at least one of the one or more computing devices to cause evapotranspiration to increase in the grow space to decrease a sensible cooling load.
63. The one or more computer-readable media of any one of the preceding embodiments starting with embodiment 45, wherein at least one of the one or more computer-readable media store instructions, that, when executed by one or more computing devices, cause at least one of the one or more computing devices to control dehumidification of the grow space or sensible heating or cooling of the grow space.
64. The one or more computer-readable media of any one of the preceding embodiments starting with embodiment 45, wherein the grow space is an enclosed grow space.
65. The one or more computer-readable media of any one of the preceding embodiments starting with embodiment 45, wherein controlling the one or more environmental conditions comprises setting the one or more environmental conditions to one or more environmental setpoints that are determined using a physics based model.
66. The one or more computer-readable media of embodiment 65, wherein the one or more environmental setpoints are also determined using an empirically based model.

### OTHER EMBODIMENTS

67. The system of any one of embodiments 1-22, wherein the lighting comprises a light module from any one of claims 67-73 below.
68. The system of any one of embodiments 1-22, wherein the lighting comprises a light module array from any one of claims 74-79 below.
69. The light module array of any one of claims 74-79 below, wherein the light module comprises the light module from any one of claims 67-73 below.

1. A control system for controlling latent and sensible loads in a grow space, the system comprising:
one or more memories storing instructions;
one or more processors, operatively coupled to the one or more memories, that execute the instructions to:
a. control one or more environmental conditions to control a latent load in the grow space,
i. wherein evapotranspiration contributes to the latent load so that a cooling effect due to the latent load exceeds a heating effect due to a sensible load; and
b. control one or more environmental conditions to control the sensible load to provide heat to at least partially offset the latent load,
i. wherein substantially all of the energy input to lighting in the grow space has the effect of warming the air in the grow space.

2. The system of claim 1, comprising: a dehumidifier for dehumidifying input air from the grow space; and a heat exchanger for transferring heat extracted by the heat exchanger from the input air to dehumidified air at the output of the dehumidifier.

3. The system of claim 1, comprising: a dehumidifier for dehumidifying input air from the grow space; and a heat exchanger for transferring heat extracted by the heat exchanger from the input air to air in the grow space.

4. The system of claim 1, wherein more than 90% of the energy input to lighting in the grow space has the effect of warming the air in the grow space.

5. The system of claim 1, wherein more than 95% of the energy input to lighting in the grow space has the effect of warming the air in the grow space.

6. The system of claim 1, wherein at least one of the sensible load or the latent load is controlled to achieve at least one desired condition.

7. The system of claim 6, wherein the at least one desired condition is a desired ambient temperature, a desired energy consumption, a desired productivity, or a desired ratio of plant product yield to energy use.

8. The system of claim 6, wherein controlling the latent load and controlling the sensible load employ machine learning to achieve the desired condition.

9. (canceled)

10. The system of claim 1, wherein evapotranspiration is controlled (a) by controlling at least one of temperature, relative humidity, vapor pressure deficit, light intensity, light wavelength, light duration, irrigation, CO₂ concentration, or air velocity, (b) by supplying chemicals that regulate transpiration, or (c) by varying lighting based on daytime or nighttime condition.

11. The system of claim 1, wherein the latent load is controlled within a control volume to achieve at least one desired condition within the control volume.

12. The system of claim 11, wherein the control volume includes lighting and the plurality of plant receptacles.

13. The system of claim 11, wherein controlling the latent load comprises receiving sensor signals representing characteristics of at least one plant in the control volume.

14. The system of claim 1, wherein the one or more memories store instructions, that when executed by at least one of the one or more processors, cause the system to employ waste heat to warm the air or evaporate moisture in the grow space.

15. The system of claim 14, wherein lighting in the grow space provides the waste heat.

16. The system of claim 15, wherein controlling the sensible load comprises cooling the lighting to control the waste heat.

17. The system of claim 1, comprising fluid-cooled lighting in the grow space, a dehumidifier for dehumidifying the grow space, and a heat exchanger, wherein the heat exchanger employs waste heat from the lighting to heat air output from the dehumidifier and provide the heated air to the grow space.

18. The system of claim 1, wherein at least one of the one or more memories store instructions, that, when executed by one or more processors, cause the system to increase evapotranspiration to decrease a sensible cooling load.

19. The system of claim 1, wherein at least one of the one or more memories store instructions, that, when executed by one or more processors, cause the system to dehumidify the grow space or sensibly heat or cool the grow space.

20. The system of claim 1, wherein the grow space is an enclosed grow space.

21. The system of claim 1, wherein controlling the one or more environmental conditions comprises setting the one or more environmental conditions to one or more environmental setpoints that are determined using a physics based model.

22. The system of claim 21, wherein the one or more environmental setpoints are also determined using an empirically based model.

23. A method for controlling latent and sensible loads in a grow space, the method comprising:
a. controlling one or more environmental conditions to control a latent load in the grow space,
i. wherein evapotranspiration contributes to the latent load so that a cooling effect due to the latent load exceeds a heating effect due to a sensible load; and
b. controlling one or more environmental conditions to control the sensible load to provide heat to at least partially offset the latent load,
i. wherein substantially all of the energy input to lighting in the grow space has the effect of warming the air in the grow space.

24.-25. (canceled)

26. The method of claim 23, wherein more than 90% of the energy input to lighting in the grow space has the effect of warming the air in the grow space.

27. The method of claim 23, wherein more than 95% of the energy input to lighting in the grow space has the effect of warming the air in the grow space.

28.-44. (canceled)

45. One or more non-transitory computer-readable media storing instructions for controlling latent and sensible loads in a grow space, wherein the instructions, when executed by one or more computing devices, cause at least one of the one or more computing devices to:
a. control one or more environmental conditions to control a latent load in the grow space,
i. wherein evapotranspiration contributes to the latent load so that a cooling effect due to the latent load exceeds a heating effect due to a sensible load; and
b. control one or more environmental conditions to control the sensible load to provide heat to at least partially offset the latent load,
i. wherein substantially all of the energy input to lighting in the grow space has the effect of warming the air in the grow space.

46.-47. (canceled)

48. The one or more computer-readable media of claim 45, wherein more than 90% of the energy input to lighting in the grow space has the effect of warming the air in the grow space.

49. The one or more computer-readable media of claim 45, wherein more than 95% of the energy input to lighting in the grow space has the effect of warming the air in the grow space.

50.-66. (canceled)

67.-79. (canceled)

80. The system of claim 1, wherein density of the plurality of plant receptacles in the grow space is such that, when plants are held in the plurality of plant receptacles, evapotranspiration contributes to the latent load so that the cooling effect due to the latent load exceeds the heating effect due to the sensible load.

81. The method of claim 23, wherein density of the plurality of plant receptacles in the grow space is such that, when plants are held in the plurality of plant receptacles, evapotranspiration contributes to the latent load so that the cooling effect due to the latent load exceeds the heating effect due to the sensible load.

82. The one or more non-transitory computer-readable media of claim 45, wherein density of the plurality of plant receptacles in the grow space is such that, when plants are held in the plurality of plant receptacles, evapotranspiration contributes to the latent load so that the cooling effect due to the latent load exceeds the heating effect due to the sensible load.
